(19) United States
(12) Patent Application Publication
(10) Pub. No.: US 2025/0227742 A1
(43) Pub. Date: Jul. 10, 2025

(54) SYSTEMS AND METHODS TO MINIMIZE RESOURCE UTILIZATION ACROSS MULTIPLE DOMAINS TO ASSURE QUALITY OF SERVICE

(71) Applicant: HUAWEI TECHNOLOGIES CO., LTD., Shenzhen (CN)

(72) Inventors: Mohamed Faraj Moftah ALZENAD, Kanata (CA); Nimal Gamini SENARATH, Kanata (CA)

(73) Assignee: HUAWEI TECHNOLOGIES CO., LTD., Shenzhen (CN)

(21) Appl. No.: 19/010,665

(22) Filed: Jan. 6, 2025

Related U.S. Application Data
(63) Continuation of application No. PCT/CN2022/104198, filed on Jul. 6, 2022.

(51) Int. Cl. H04W 72/52; H04L 41/5067; H04W 24/08; H04W 72/51; H04W 72/543

(52) U.S. Cl. CPC H04W 72/52; H04L 41/5067; H04W 24/08; H04W 72/51; H04W 72/543

(57) ABSTRACT

For future generation networks, it has been proposed to establish an autonomous networking framework where the customer-provider interaction can happen autonomously. In the multi-domain interactions paradigm, it is important that the resource usage be minimized when providing a service or service slice to a customer while ensuring the quality of service. By dividing a geographic area into separate grids and combining grids requiring a similar resource allocation, historical analysis can allow an estimation of future resource requirements. During service provision or during run-time, the customer requirement can be obtained as a statistical distribution of the expected demand over the given geographic area. The problem of resource allocation is thus addressed by leveraging the concepts of a gridded map, domain abstraction by learning the resource usage of communication services, and conversion of a customer requirement to grid-based requirements

### CROSS-REFERENCE TO RELATED APPLICATIONS

This application is a continuation of International Application No. PCT/CN2022/104198, filed on Jul. 6, 2022, the disclosure of which is hereby incorporated by reference in its entirety.

### TECHNICAL FIELD

This invention pertains generally to the field of network slicing and in particular, to systems and methods to minimize the resource utilization of a service slice.

### BACKGROUND

A communication service provider can provide three types of services to its customers: connectivity service, network as a service, and infra-structure as a service. In all three cases, the provider has to allocate its own resources and/or take additional resources or services from external providers (i.e., 3rd party suppliers). These resources and services may belong to different technical domains, such as a radio access network (RAN), a core network (CN), a transport network (TN), or to administration domains, which can be managed by different administrations.

For future generation networks, it has been proposed to establish an autonomous networking framework where a customer-provider interaction can happen autonomously. In a paradigm of multi-domain interactions, when providing a service to a customer, it is important for resource usage to be minimized and that quality of service be ensured. Reducing resource usage has several advantages including lowering service cost and expanding service capability.

During the life cycle of a network slice, resource reservation, activation, updating, and deactivation are managed during a provisioning phase and an operation (run-time) phase. In the provisioning phase, the required resources are reserved and configured so as to satisfy the customer's service requirements for as long as the network slice is expected to exist. The prior art includes numerous techniques for minimizing resource utilization during a provisioning phase. A customer usually provides a maximum data rate that has to be supported, as well as a peak number of users for different time intervals, within a large geographic area. Users to be served are dropped on the service area, i.e., they are located on the service area according to the customer demand (this is a one drop of users).

When generating a user drop, the locations of the potential group of users that can be available at a given time are generated using a computer program. This location distribution of the users is called a user drop. For example, if a customer provides a statistical distribution of users in a service area, the locations are determined according to the statistical distribution. In another example, a customer can provide a maximum number of users to be served in the service area and users in that amount can be randomly dropped in the area. Then, more user drops can be generated by repeating this until a representative number of user drops is generated.

When resources are allocated during a provisioning phase, a method of the prior art can include carrying out a Monte Carlo type analysis based on simulations where a large number of user drops are generated according to a customer requirement.

Then, determining the minimum amount of resources needed for each drop. And finally, finding the resource requirement to satisfy all the user drops.

Although much work has been done, a problem that remains is to find the minimum resource requirement that can satisfy all the user drops. This is generally much less than the minimum amount that is found using simulations where each drop is considered independently. With simulations, the amount of resources needed is the maximum of each resource type, determined for each user drop. Furthermore, because they are time-consuming, simulation methods cannot be used for automated network provisioning.

With the limitations in the available resources and the dynamic nature of a demand, overprovisioning of resources for the lifetime of a network slice to accommodate the resources needed during run time is not an efficient policy for resource allocation. Service demand (e.g., traffic demand) is dynamic in nature and often unpredictable, especially during the provisioning phase. While a network is running, the service demand, and hence resource requirements, may decrease in comparison to what was initially agreed upon in the service level agreement (SLA). This in turn can result in the resources reserved for the network slice not being fully utilized. Keeping these resources for the running network slice is not a cost efficient decision. For example, a virtual machine running with overprovisioned computing resources will consume energy even though an associated virtual network functions (VNF) is not fully consuming the allocated computing resources.

This background information is provided to reveal information believed by the applicant to be of possible relevance to the present invention. No admission is necessarily intended, nor should be construed, that any of the preceding information constitutes prior art against the present invention.

### SUMMARY

The deactivation or release of unused computing resources can result in a more cost efficient slice operation. In embodiments, solutions and methods are provided to minimize resource usage during the provisioning phase and run time phase of a network slice (service slice) provided to a customer across multiple domains, while the customer's QoE is assured. In addition, because historical learning data is already available, a minimum resource cost solution can readily be found.

A central issue that needs to be addressed in the QoE assurance is how to guarantee the service requirements without over-provisioning the resources. If the allocated resources are over-provisioned, additional costs will be incurred unnecessarily. In contrast, if resources are insufficient the quality of experience (QoE) may also be insufficient. Resource allocation considerations in a service provisioning stage and in an operation stage, can be quite different.

Technical effects and benefits of embodiments include an economy of computing resources when provisioning or running a service slice. By analyzing the resources required to provide a service slice to traffic over a geographic area for a certain amount of time, a future resource allocation for the area can be estimated, and an amount of resources can be determined that is sufficient to avoid outages, but not excessive, so as to preserve resources for alternative or future uses.

By receiving data describing customer demand over a certain geographic area, a representation of the area can be divided into grids and those grids with similar network parameters can be combined virtually. An analysis of the resource required for each combination of grids over a certain time, can allow a future a future amount of resource allocation to be estimated for each grid, over a certain interval of time, thereby freeing resources for other uses. This can be done during a slice provisioning phase.

While a service slice is in operation, a network slice manager can also receive data describing customer demand over a certain geographic area and virtually combine those have similar requirements, and analyze past usage of resources. Potential future demand profiles can be generated, and resources can be assigned to the potential future demand profiles. This can be done during slice operation, i.e. during run-time.

A system to perform a method according to embodiments includes a processor and suitable instructions during a provisioning phase, which can be implemented as a slice resource allocator to perform a method according to embodiments during a provisioning phase or a run-time phase.

Embodiments include a method of provisioning a service slice. Such a method includes receiving a statistical representation of a customer traffic demand over a specified geographic area, the customer traffic demand being an aggregated traffic demand of an end user population, associated with a customer, and to be met by the service slice. The specified geographic area is divided into a set of geographic grids of equal size. Such a method further includes determining a set of geographic grid demand profiles for the set of geographic grids operative to support the statistical representation of a customer traffic demand, with each geographic grid served by at least one base station. Such a method further includes determining an amount of resources that is sufficient to satisfy each geographic grid demand profile of the set of geographic grid demand profiles; and sending an indication of the amount of resources to at least one network manager to implement the service slice.

In some embodiments, a service slice spans a plurality of domains.

In some embodiments, determining a set of geographic grid demand profiles includes determining a set of virtual grid demand profiles for a set of virtual grids operative to support the statistical representation of a customer traffic demand, with each virtual grid being a set of geographic grids having similar radio network parameters, the set of geographic grids being of similar size and covering the specified geographic area. In such a embodiments, the method further includes determining an amount of resources includes determining a common set of resources to satisfy each virtual grid demand profile in the set of virtual grid demand profiles, the amount of resources including resources from one or more of the plurality of domains and indicating the amount of resources for each resource type required; and the method further includes the network manager sending a request, to one or more domain managers of the plurality of domains, to implement the service slice using the amount of resources, according to the indication.

In some embodiments, determining a common set of resources includes performing a historical analysis of resource usage information of past time intervals for various services using monitored data on resource usage in each domain for each virtual grid; providing the results of the historical analysis to a resource modeller; and determining by the resource modeller the common set of resources to satisfy the set of virtual grid demand profiles.

In some embodiments, the historical analysis includes analyzing the monitored data to determine the resources required for each domain to provide a data unit of traffic (RRUT) for each virtual grid, for each service type or quality of service (QoS), for each potential traffic path at different network states.

In some embodiments, the historical analysis includes analyzing the resources required for each domain for each potential virtual grid demand profile in the geographic area; quantizing the virtual grid demand profiles to reduce the number of potential virtual grid demand profiles by quantizing each virtual grid demand into a few quantized demand levels; analyzing a resource requirement similarity among the quantized virtual grid demand profiles; classifying the quantized virtual grid demand profiles into a smaller distinguished set of virtual grid demand profiles using the resource requirement similarity analysis; and determining an amount of resources required to satisfy each virtual grid demand profile of the smaller distinguished set of virtual grid demand profiles.

In some embodiments, determining a common set of resources includes determining, by a resource modeller, a common resource assignment from each domain to satisfy the set of virtual grid demand profiles by an optimization algorithm using the results of a historical analysis of resource usage for different traffic demands.

In some embodiments the statistical representation of the customer traffic demand over a specified geographic area includes quality of experience requirements and outage requirements over the geographic area.

In some embodiments, a method further includes obtaining a historical analysis of past traffic demand profiles to determine a set of correlated grids by combining geographic grids until a minimum traffic demand correlation is observed among the correlated grids in the set of correlated grids.

In some embodiments, determining a set of virtual grid demand profiles for a set of virtual grids operative to support the statistical representation of a customer traffic demand includes determining a set of potential traffic demand profiles across the virtual grids to represent the statistical representation of the customer traffic demand such that satisfying the potential demand profiles satisfies the statistical representation of the customer traffic demand.

In some embodiments, determining a set of potential traffic demand profiles across the virtual grids to represent the statistical representation of the customer traffic demand such that satisfying the potential demand profiles satisfies the statistical representation of the customer traffic demand includes determining a potential set of traffic demand profiles across the correlated grids based on the correlation among the correlated grids and distributing the correlated grid traffic demands of a traffic profile to its grids; and combining the resulting grid traffic of a virtual grid to determine the virtual grid demand profiles.

In some embodiments, receiving a statistical representation of a customer traffic demand includes determining previous grid demand profiles based on monitoring changes of the traffic demand over regular intervals.

In some embodiments, a method further includes revising a resource assignment for a customer, based on an ongoing monitoring of resource usage for previous grid demand profiles, and revising assigned resources to satisfy expected future virtual grid demand profiles.

Embodiments further include a method of operating a service slice. Such a method includes receiving a statistical representation of a customer traffic demand over a specified geographic area; the specified geographic area is divided into a set of geographic grids of equal size. Such a method further includes determining a set of geographic grid demand profiles for a set of geographic grids operative to support the statistical representation of a customer traffic demand, with each geographic grid served by at least one base station. Such a method further includes analyzing the geographic grid demand profiles for an associated resource usage and performance, as monitored over one or more past time intervals. Such a method further includes assigning resources to satisfy potential geographic grid traffic demand profiles over a future time interval; and sending a request to at least one network manager to implement the service slice using the assigned resources.

In some embodiments, determining a set of geographic grid demand profiles includes determining a set of virtual grid demand profiles for a set of virtual grids operative to support the statistical representation of a customer traffic demand, with each virtual grid being a set of geographic grids with similar radio network parameters, the set of geographic grids being of similar size and covering the specified geographic area. In some embodiments analyzing the geographic grid demand profiles includes determining a virtual grid traffic demand variation based on analyzing a time correlation, and a spatial correlation.

In some embodiments, the potential virtual grid traffic demand profiles for a future time interval is determined using the analysis of the virtual grid demand profiles based on analyzing a time correlation and a spatial correlation.

In some embodiments, assigning resources to satisfy potential virtual grid traffic demand profiles includes determining an amount of resources to be allocated to avoid an outage or an excessive resource allocation, based on the determined virtual grid traffic demand variation.

In some embodiments, determining an amount of resources to be allocated to avoid an outage or an excessive resource allocation includes preparing a look-up table of outage percentages at different values of a grid traffic demand variation, a time correlation, and a spatial correlation; wherein the look-up table is prepared using an offline generation of potential demand profiles for a given grid demand variation, a time correlation, and a spatial correlation; and determining outage values for different percentages of resource increase or decrease at a given time using a historical analysis of resource usage per grid per service.

In some embodiments, the one or more past time intervals are determined based on monitoring a virtual grid traffic demand variation, a time correlation, and a spatial correlation observed during the one or more past time intervals.

Embodiments further include a system for provisioning a service slice, comprising at least one processor, and machine readable memory storing machine readable instructions which when executed by the at least one processor, configures the at least one processor to implement a slice resource allocator. The slice resource allocator is operative to receive a statistical representation of a customer traffic demand requirement over a specified geographic area, the customer traffic demand being an aggregated traffic demand of an end user population, associated with a customer, and to be met by the service slice. The specified geographic area is divided into a set of geographic grids of equal size. Such a slice resource allocator is further operative to determine a set of geographic grid demand profiles for the set of geographic grids operative to support the statistical representation of a customer traffic demand, with each geographic grid served by at least one base station.

Such a slice resource allocator is further operative to determine an amount of resources that is sufficient to satisfy each geographic grid demand profile of the set of geographic grid demand profiles; and send an indication of the amount of resources to at least one network manager to implement the service slice.

In some embodiments the service slice spans a plurality of domains.

In some embodiments such a slice resource allocator is configured such that, determining a set of geographic grid demand profiles includes determining a set of virtual grid demand profiles for a set of virtual grids operative to support the statistical representation of a customer traffic demand, with each virtual grid being a set of geographic grids with similar radio network parameters, the set of geographic grids being of similar size and covering the specified geographic area. In some embodiments such a slice resource allocator is configured such that, determining an amount of resources includes determining a common set of resources to satisfy each virtual grid demand profile in the set of virtual grid demand profiles, the amount of resources including resources from one or more of the plurality of domains and indicating the amount of resources for each resource type required. In some embodiments such a slice resource allocator is further operative such that the network manager sends a request, to one or more domain managers of the plurality of domains, to implement the service slice using the amount of resources, according to the indication.

Embodiments further include a system for operating a service slice during run-time comprising at least one processor, and machine readable memory storing machine readable instructions which when executed by the at least one processor, configures the at least one processor to implement a slice resource allocator, the slice resource allocator operative to: receive a statistical representation of a customer traffic demand profiles monitored over a geographic area for one or more past time intervals; determine a set of virtual grid demand profiles for a set of virtual grids operative to support a customer traffic demand at a future time interval, with each virtual grid being a set of geographic grids with similar radio network parameters, the set of virtual grids covering the specified geographic area; analyze the set of virtual grid demand profiles for associated resource usage and performance for one or more past time intervals; determine an amount of resources that is sufficient to satisfy each virtual grid traffic demand profile during the future time interval; and send a request to at least one network manager to implement the service.

Embodiments further include a method to find an amount of resources required to satisfy a service slice during a run time operation comprising carrying out a historical learning process, the historical learning process including monitoring grid traffic demand profiles and associated resource usage and outages over one or more past time intervals; determining ranges of variation for different statistical parameters of the monitored grid traffic demand profiles, including ranges for mean demands, standard deviations, time correlations, and spatial correlations; generating with software a plurality of grid traffic demand profiles, using different values in the ranges of variation for different statistical parameters; and determining historical outage values corresponding to different levels of resource increases and decreases; monitoring the grid traffic demand profiles over a past time interval; analyzing a variation of statistical parameters of the grid traffic demand profiles; and determining a required increase or decrease in resource to achieve a specified outage, based on the historical outage values corresponding to different levels of resource increases and decreases.

Embodiments further include systems and apparatus including at least one processor, and machine readable memory storing machine readable instructions which when executed by the at least one processor, configures the at least one processor to perform any of the methods discussed herein.

Embodiments further include machine readable memory storing machine readable instructions which when executed by at least one processor, configures the at least one processor to perform any of the methods discussed herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1 illustrates how a network slice can consist of several network subslices belonging to different administrative domains, according to an embodiment.

FIG. 2 illustrates how a network slice can be provisioned by obtaining segments from different segment providers, according to an embodiment.

FIG. 3 illustrates a high-level view of a network, including entities used by a slice provider, to which methods according to embodiments can be applied.

FIG. 4a to FIG. 4b represent a flow chart of functions used to optimize resource assignment during the provisioning phase of a slice, according to some embodiments.

FIG. 5a to FIG. 5c represent a flow chart of functions used to optimize resource assignment during the run-time phase of a slice, according to some embodiments.

FIG. 6 illustrates an example of a network segment with two ingress ports, two egress ports, and multiple internal network functions, according to an embodiment.

FIG. 7 illustrates how a RAN segment can be abstracted by using as ingress or egress ports grids defined by the amount of resources they require, according to an embodiment.

FIG. 8a illustrates five traffic demand profiles for a service entitled “service 1”, according to an embodiment.

FIG. 8b illustrates five traffic demand profiles for a service entitled “service 2”, according to an embodiment.

FIG. 9 is a graph illustrating the time intervals used to monitor traffic, and to predict resource allocations, according to an embodiment.

FIG. 10 illustrates for each of thirteen grids, a future traffic demand profile, as predicted by a time series analysis taking into account both time correlation and spatial correlation of three past traffic demand profiles, according to an embodiment.

FIG. 11 illustrates two possible user distributions, each one with a particular number of users in each of two geographic areas, as well the base stations serving them and the amount of resources needed to serve one unit of traffic, according to an embodiment.

FIG. 12 illustrates a network including a RAN, a TN, and a CN, and grids of a service area, according to an embodiment.

FIG. 13 illustrates a functional diagram for a distributed AI-based resource allocation scheme, according to embodiments.

FIG. 14 is a graph showing the ratio of an optimization-based resource allocation according to embodiments, to a simulation-based resource allocation according to embodiments, for five types of resources, with a system as shown in FIG. 12.

FIG. 15 illustrates a method to update the resource allocation across multiple domains to a slice in operation, according to an embodiment.

FIG. 16a shows an example of five predicted traffic profiles over 12 grids, created using a correlation model with a time correlation value of 0.7, according to an embodiment.

FIG. 16b shows an example of five predicted traffic profiles over 12 grids, created using a correlation model with a time correlation value of 0.6, according to an embodiment.

FIG. 17 shows the resource usage ratio of the optimization-based scheme to the scheme based on percentage increase of resources, according to embodiments.

FIG. 18a to FIG. 18d represent a call flow diagram for a resource minimization procedure during provisioning phase, according to an embodiment.

FIG. 19a to FIG. 19d represent a procedure to allocate resources to a slice during run-time, according to an embodiment.

FIG. 20a to FIG. 20d represent a hybrid procedure for network slice resource adaptation during run-time, according to an embodiment.

FIG. 21 is a block diagram of an electronic device (ED) 952 illustrated within a computing and communications environment 950 that may be used for implementing the devices and methods disclosed herein, such as a system for provisioning a service slice.

It will be noted that throughout the appended drawings, like features are identified by like reference numerals.

### DETAILED DESCRIPTION

The deactivation or release of unused computing resources, e.g. CPUs of different computing power, storage, energy and special infra-structure, can result in a more cost efficient slice operation. In embodiments, solutions and methods are provided to minimize resource usage during the provisioning phase and run time phase of a network slice (service slice) provided to a customer across multiple domains, while the customer's QoE is assured. In addition, because historical learning data is already available, a minimum resource cost solution can readily be found.

A central issue that needs to be addressed in the QoE assurance is how to guarantee the service requirements without over-provisioning the resources. If the allocated resources are over-provisioned, additional costs will be incurred unnecessarily. In contrast, if resources are insufficient the quality of experience (QoE) may also be insufficient. Resource allocation considerations in a service provisioning stage and in a run-time stage can be quite different.

In service provisioning, long-term resource requirements must be assessed based on the SLA requirements specified for the duration the network slice is expected to be in operation. The SLA can specify different requirements for different time zones (e.g., peak hours, etc.), and the resources that need to be prepared for those time zones, separately.

During the operation of the service (at run-time), the resources needed for a given network slice can change dynamically, e.g., following changes in traffic demand. Keeping the resources that were allocated during the provisioning phase can result in a QoE degradation or an avoidable cost. Updating network slice resources during the run-time phase can be realized if the traffic demand can be predicted for short time durations to a certain accuracy. This is useful when a network provides multiple network slices where the resources or the service capacity of one slice could be temporarily released to other slices, based on a prediction, without violating the SLA requirements.

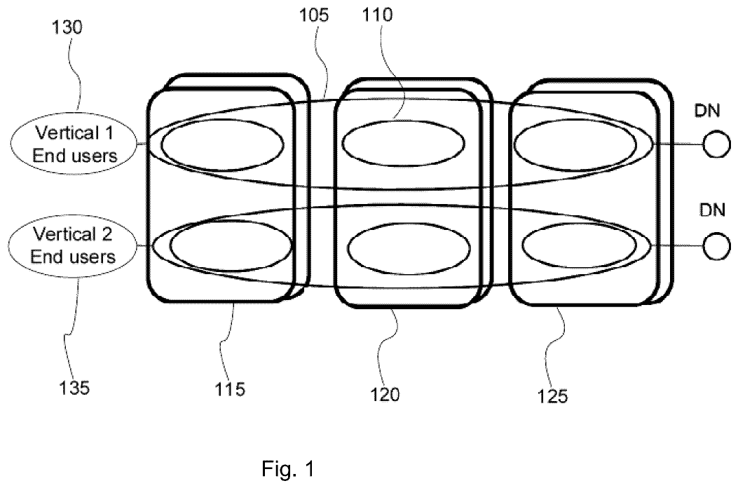

FIG. 1 illustrates how a network slice can consist of several network subslices belonging to different administrative domains, according to an embodiment. A slice 105 can include a plurality of subslices 110, each subslice belonging to a different domain, such as a RAN domain 115, a TN domain 120, or a CN domain 125. Each slice can be a service for end users identified as vertical 1 end users 130 or vertical 2 end users 135.

Embodiments include a method, applicable to the provisioning phase, to evaluate the resources needed across multiple domains to provide a service (i.e., network slice) to a customer, when the customer provides a statistical distribution of the demand for that service, over a geographic area. A customer can also provide multiple statistical distributions, corresponding to different time periods. Therefore, embodiments provide a mechanism to evaluate the resource requirements for different types of customer distributions.

Embodiments also provide a method, applicable in the run time phase, to update the resources of a running network slice that is provided to a customer across multiple domains with quality assurance. For example, the customer can be a mobile virtual network operator (MVNO) providing a communication service to a pool of users having subscribed to the MVNO service. In some cases, the customer can be a “vertical” which is a term used to refer to a business entity providing a service such as a communication service provider for an enterprise, a mobile virtual network operator (MVNO) providing a service to a subscribed population, or a company operating a large number of sensors (end users) to monitor various environmental parameters. As illustrated in FIG. 1, a slice provider might be using multiple subslices (i.e., network segments that belong to different administrative domains (e.g., RAN, TN & CN domains) to create a slice. In addition, the slice provider may have to offer multiple network slices (network slice 1 & 2) to different customers (vertical 1 end users and vertical 2 end users). Each customer might need the network slice to provide a service from its end users to a data network (DN) for uplinks, or from a DN to end users for downlinks, and this end-to-end (E2E) quality of experience (QoE) of the customer should be guaranteed during slice operation.

In embodiments, a business player is a business entity providing a communication service to its customers using a communication service. For example, business player can be a vertical, a mobile network operator (MNO), an infra-structure provider, a network segment, or even a domain owner providing a communication service using a network segment.

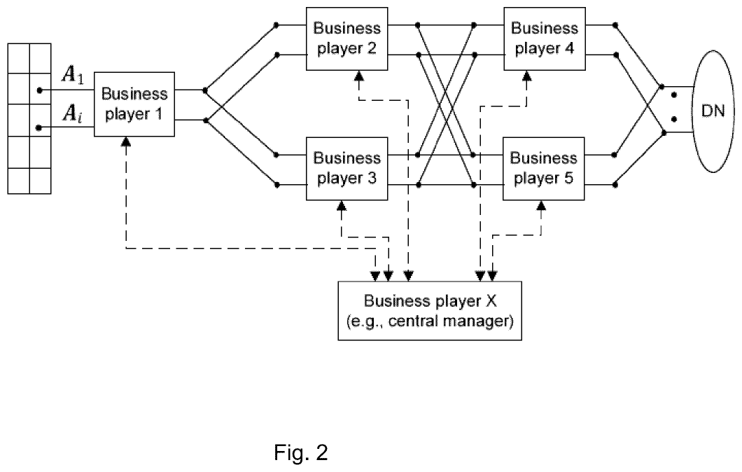

FIG. 2 illustrates how a network slice can be provisioned by obtaining segments from different segment providers, according to an embodiment.

The central manager of service provider (business player X) may need to obtain services or resources such as network segments from different technical or administrative domains. These domains may be owned by different business players (business players i, where i=1, 2, . . . 5) and the central manager needs to interact with these domains, as indicated by dashed arrows, to deliver an E2E service between virtual ports Aᵢ (i=1, 2, . . . ) and the DN. The subscribers or customer devices are distributed over a geographic area which is served by the business players who administrate the RAN domains (business player 1). The service area can be divided into grids, where each grid is considered to be a virtual port Aᵢ.

In FIG. 2, a service slice is a service provided by using a slice of network resources, i.e., a service slice is provided using a network slice. Each domain can also provide a service slice to the business player X, instead of providing a resource slice to the business player. In that case, a domain is not exposing its resources to the business player and the domain is referred to as a “closed” domain, as opposed to an “open” domain where the domain exposes its resources to business player X.

To assure the QoE of a slice provided to a customer, two requirements should be met. A slice provider can assure QoE by first, providing adequate resources during the provisioning stage, and secondly, by assuring QoE during the operation, by using the minimum amount of resources and dynamically sharing resources among other slices

Embodiments provide solutions for both of these requirements, i.e., how to assign a minimum amount of resources in different domains, during both slice provisioning and slice run time.

During service provisioning, a service provider can receive from a customer, statistics of a demand distribution for a given time period. The provider can convert the statistics to a set of demand profiles based on a geographic grid, a set of “expected traffic demand profiles” (ETDP). The provider can then use a developed mechanism (i.e., framework), as well as historical resource requirement data based on the grid, to find a minimum resource requirement in each domain, to satisfy the demand profiles.

During the service's run time phase, traffic and resource usage data can be monitored over a past interval of time, to extract traffic and resource usage statistics, such as traffic variations, and time and space correlations. Traffic can then be predicted for a determined, future interval of time, based on the historical changes of the traffic. The resource requirements of the network slice can then be updated to satisfy the predicted, future traffic. In this way, resources can be allocated efficiently, while QoE is guaranteed. If needed, the unused resources can be deactivated or released, so as to be available for other network slices.

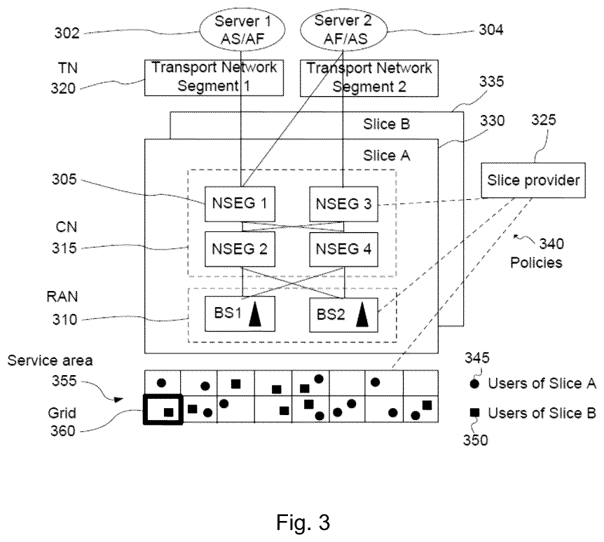

FIG. 3 illustrates a high-level view of a network, including entities used by a slice provider, to which methods according to embodiments can be applied. The network consists of a server 1 (application server/application function 1) 302, a server 2 (application server/application function) 304, multiple external network segments (NSEGs), such as NSEG1 305, which can be controlled by different administrative domains, such as a radio access network (RAN) 310, a core network (CN) 315, and a transport network (TN) 320. When a slice provider 325 provides a service to end users, e.g., users 345 of service slice A 330 and users 350 of service slice B 335, it obtains or provisions the service slice (330, 335) operating from a network slice. Although a network slice can provide multiple service slices (330, 335), embodiments include a case where one network slice provides one respective service slice (330, 335). In such a case, the terms “network slice” and “service slice” can be used interchangeably.

An end-to-end (E2E) service slice can include one or more RAN NSEGs, one or more CN NSEGs and one or more TN segments, and to provide such a service slice, a service provider 325 has to obtain slices of NSEGs and combine them to provide the E2E service slice. The slice provider 325 can use a central Operation and Administration Manager (OAM) when provisioning a new service slice, as well as during its operation i.e., at run-time. Each NSEG has its own OAM components (e.g., a RAN manager, a CN manager, and a TN manager) and the central OAM interacts with these OAM components during both provisioning time and during run-time. For a RAN NSEG, the service area 355 is divided into “grids” 360, allowing a grid-based resource assignment.

To obtain a subslice from a NSEG and create a corresponding network slice, the service provider 325 has to assess the resources or service requirements from the NSEG. For this purpose, the service provider 325 needs to obtain network details of the NSEG such as the service capabilities, the resource capabilities, and/or an abstracted view of the same. The slice provider 325 might also have to obtain input and output addresses, as well as other operational features, such as dynamic interaction procedures and/or protocols with other NSEGs. When a central OAM obtains the relevant information of the NSEG, the slice provider 325 can assess the service and resource requirements that are expected from each other NSEG. After that, the slice provider can send a request to each NSEG manager to establish the subslices, and to provide the required usage procedures. As can be seen in FIG. 3, the slice provider 325 also has to provide policies 340 of slice control to the individual subslices or subnets.

A framework according to an embodiment can learn historical data, in order to allocate a minimum amount of resources to a network slice, during a future time interval. For a provisioning phase, this future time interval is the time interval during which the network slice is expected to be in operation; while for the run-time phase, it is the time interval during which the network slice resources are to be updated. The framework allocates resources across multiple domains, while assuring the QoE of the network slice, as required by a slice customer.

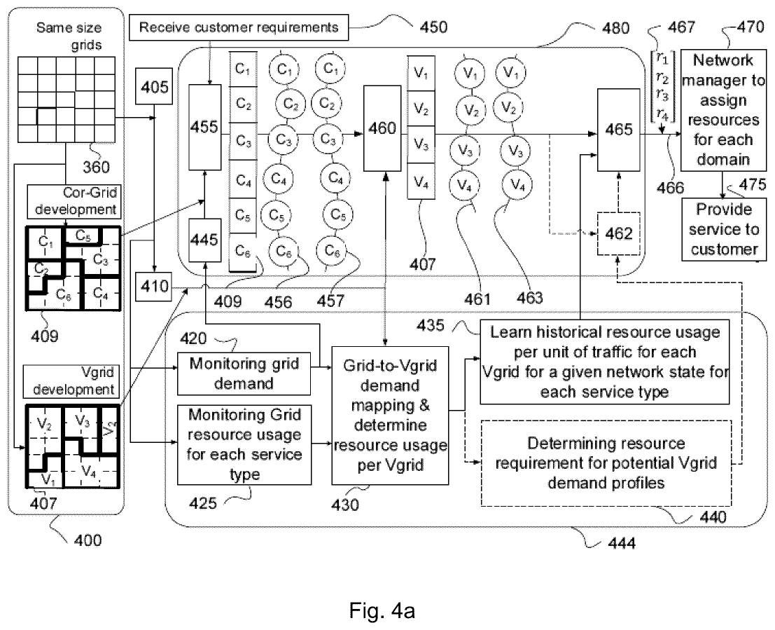

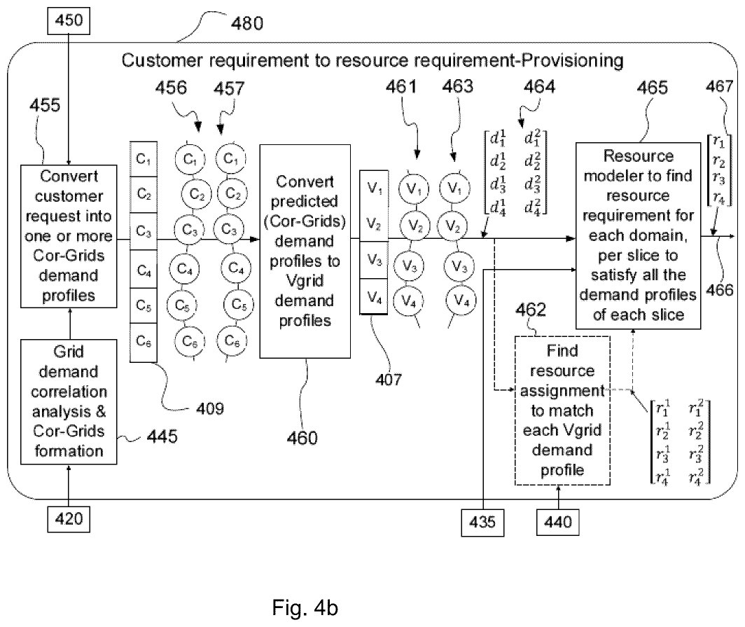

FIG. 4a to FIG. 4b represent a flow chart of functions to be used to optimize resource assignment during the provisioning phase of a slice, according to some embodiments. It should be appreciated that FIG. 4b shows details of a slice resource allocator 480 in FIG. 4a. Initially, a service area 355 of equally sized grids 360 can be created 405 to map the service area that is to be provisioned by a slice. An example of a service area with 25 grids 360 (5 grids×5 grids) is shown in block 400 in FIG. 4a. Each grid served by at least one base station (BS). In other each grid is in the coverage area of one or more BSs.

Then, based on similarities in path loss between a geographic grid and a set of BSs (e.g., BSs with strongest received power), in some embodiments, virtual grids (Vgrid) 407 can be developed 410 from geographic grids 360. This is partly to simplify the analysis by reducing the number of grids used in the analysis, and, in some embodiments the analysis discussed herein can be implemented using geographical grids without forming Vgrids. A range of path losses can be discretized into intervals, possibly with different discretization levels. Geographic grids 360 having path losses from their respective base stations in a similar range, can be combined into the same virtual grid 407 (Vgrid). A Vgrid 407 therefore includes a set of geographic grids 360. To form Vgrids from geographic grids, a set of strongest BSs, the set of BSs having highest signal strength or lowest path loss to a given grid, is first determined. Then the path loss from a geographic grid to the strongest BSs is discretized. This is done for the service area's geographic grids. Finally, the geographic grids having similar path loss levels and matching strongest BSs, are included in the same Vgrid.

To determine which base stations to include in a Vgrid, a variety of factors can be considered, such as the number of BSs having enough strength. Similarly, grids can also be combined based on a similarity of resource usage, i.e., grids having a similar resource usage can be combined into the same Vgrid. After the following actions have also been performed, a Vgrid can then be used to convert 460 a predicted Cor-Grid demand profile to a predicted Vgrid demand profile. In FIG. 4a, a Vgrid 407 combining a group of geographic grids 360 is identified with notation Vₖ, with k being an index identifying the Vgrid.

For clarity, each virtual grid of an embodiment can be a set of geographic grids with a similar radio network parameter; the set of virtual grids covering the specified geographic area covered by a service or slice (when a customer traffic demand requirement is received, the requirement is over a specified geographic area). It is noted that in an embodiment, a similarity can be a similar radio network parameter such as a similar path loss, but it should be appreciated that other radio network parameters, such as signal strength, can be used. Note that the BS here represent any radio transmit point such as an antenna, remote radio unit (RRU) or a road side unit (RSU). As stated above, the virtual grids are formed to simplify the analysis by reducing the number of grids used in the analysis. However, this is not necessary in all embodiments, so it should be noted that in some embodiments, each set of geographic grids can include one or more geographic grids. For each set of geographic grids for which the set equals one, this is equivalent to using the virtual grids themselves.

Once a service area is divided into grids, traffic originating to or from each grid can be monitored in terms of historical demand 420 per service, and in terms of resource usage 425 of the processing nodes per service. Processing nodes can be located in different domains, such as RAN domains 310 and CN domains 315. Examples of such processing nodes are base stations and network functions.

Then, for each geographic grid, the historical demand per service and the resource usage of processing nodes per service can respectively be converted 430 into a Vgrid demand per service and a Vgrid resource usage per service. Then, a network abstraction can be done for E2E paths in each domain, including parallel connected domains and/or serially connected domains. Embodiments include two types of historical usage analysis, as illustrated in block 444. It should be noted that in some embodiments, one or both types of analysis can be used.

A first type of historical usage analysis is to find, for a given network state, a historical resource requirement for each virtual grid. In other words, to learn 435 historical resource usage per unit of traffic for each Vgrid for a given network state for each service type. This can allow an assessment of the resources required to provide a data unit of traffic (RRUT), to obtain a specified quality of service (QoS) for a traffic flow or a service type for a particular traffic path or considering a given system feature, such as multiple-input, multiple-output (MIMO), or usage of different beam forming technologies. This assessment can be done at different network states, by monitoring and self-learning. Note that there can be multiple resource requirements for the same RRUT per same QoS in a grid, based on which system feature is used, the network state, and which routing path is used. These possible RRUT values can be learned and stored in this historical learning process.

A second type of historical usage analysis is to determine 440 resource requirements for potential Vgrid demand profiles (method 2) by analyzing the resources required for each domain for each potential virtual grid demand profile in the geographic area, quantizing the virtual grid demand profiles to reduce the number of potential virtual grid demand profiles by quantizing each virtual grid demand into a few quantized demand levels, analyzing a resource requirement similarity among the quantized virtual grid demand profiles, and classifying the quantized virtual grid demand profiles into a smaller distinguished set of virtual grid demand profiles using the resource requirement similarity analysis. Quantizing is done by quantizing the continuous representation of traffic demands into a number of quantised levels with a certain granularity to reduce the number of Vgrid demand profiles. Then these quantized demand profiles are further classified into a smaller number of Vgrid demand profiles using the resource requirement similarity among the Vgrid demand profiles observed by historical learning. In other words, this includes determining 440 resource requirements for a set of potential Vgrid demand profiles (method 2) which are a representative set for all the possible demand profiles for resource analysis purpose. A demand profile can also be referred to as an expected traffic demand profile (ETDP). Because there is a large number of potential demand profiles, quantization and/or classification techniques described above can be applied to limit the number of potential demand profiles.

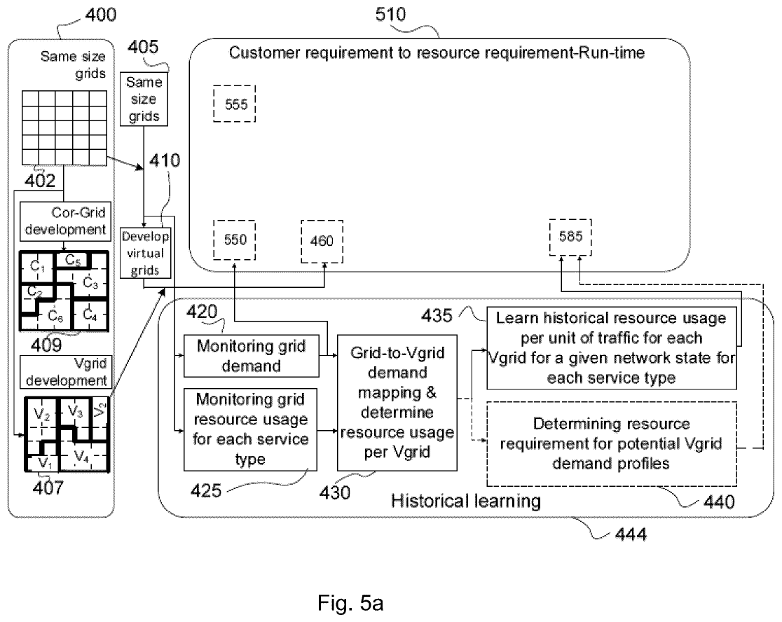

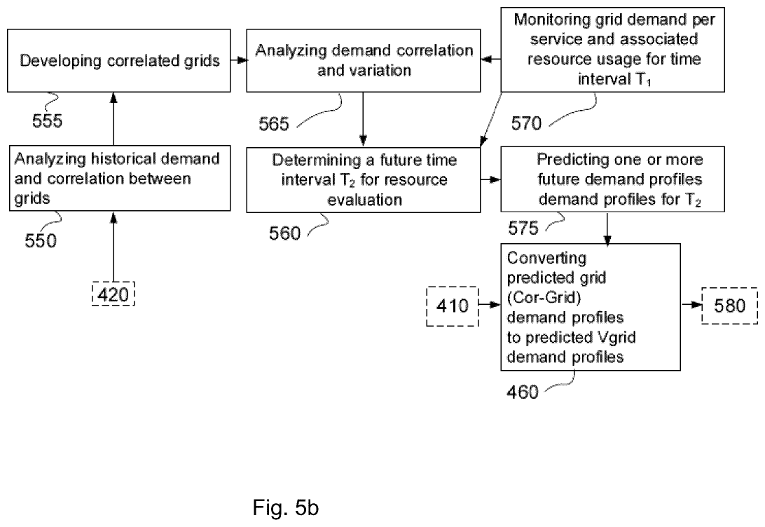

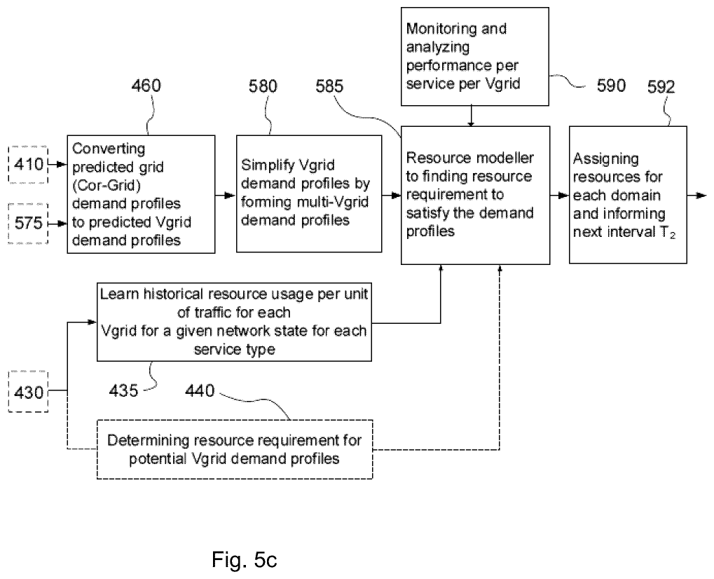

The process 444 of monitoring historical demand 420 or resource usage 425, conversion 430 into a Vgrid demand per service and a Vgrid resource usage per service, and finding 435 a historical resource requirement for each virtual grid, or quantizing 440 and classifying the Vgrid demand profiles into a smaller distinguished set of Vgrid profiles, and determining by historical learning, the resource requirement similarity for each quantized Vgrid demand profile can be combined into a set of steps that can be used for various embodiments (such as in FIG. 5a).

By monitoring 420 a geographic grid for historical demand per service, the traffic demand can be analyzed to obtain 445 demand statistics, such as a correlation between the demands from two geographic grids. In some cases, e.g., if no correlation or a very low correlation exists between two geographic grids, a correlated grid (Cor-Grid) can be formed by combining geographic grids until a traffic correlation between the grids is observed. For example, the 25 geographic grids 360 obtained in FIG. 4a can be mapped to 6 Cor-Grids 409 (separated by a thick line in FIG. 4a).

After obtaining correlations 445 between geographic grids, as well as customer demand statistics 450 for the communication service (service requirements) for the expected operation time of the slice in the geographic region of the grids, a customer request can be converted 455 into one or more demand profiles based on correlated grids, instead of virtual grids. For a provisioning phase, service requirements are in a service level agreement (SLA).

The demand profiles based on correlated grids, or Cor-Grid demand profiles, which are a plurality of expected traffic demand profiles (ETDPs), for different services across a grid. An ETDP is determined based on how a customer specifies service requirements over the area, including the distribution of users or traffic. It can be specified as a statistical distribution over a geographic area, an average value over an area, or a peak of aggregated demand. Spatial correlation of traffic in different grids can also be used when ETDPs are generated during a provisioning phase. As shown in FIG. 4b, using a Cor-Grid 409, a customer demand can be mapped to multiple Cor-Grid demand profiles. FIG. 4b shows two example Cor-Grid profiles, a first Cor-Grid demand profile 456 and a second Cor-Grid demand profile 457. In FIG. 4b, each circle of a demand profile 456, 457, 461, 463 represents the traffic demand of a respective Cor-Grid or Vgrid, while a curved line represents a profile. For simplicity, only two Cor-Grid demand profiles are shown, but there can be more. Each Cor-Grid demand profile represents the traffic demand distribution over Cor-Grids 409. The traffic demand of a Cor-Grid is determined by aggregating the traffic demand of each grid belonging to a Cor-Grid. Also, the traffic demand is described separately for each type of communication service or each type of traffic.

By considering the information used to develop 410 a Vgrid 407, each correlated grid demand profile 456, 457 (and others if there are more) can be converted 460 to a respective Vgrid demand profiles: e.g., a first Vgrid demand profile 461 and a second Vgrid demand profile 463, however there can be many more). This can be done, for example, by equally distributing the traffic demand of each Cor-Grid within the grids it contains and secondly, aggregating the traffic of the geographic grids belonging to the same virtual grid. FIG. 4b shows two Cor-Grids demand profiles as an example. The resultant Vgrid demand profiles are shown as a matrix 464 where an element dᵢ^{j} represents the demand of Vgrid i of Vgrid demand profile j.

A resource modeller can then be used to determine 465 the minimum amount of resources required from each domain resources, for each slice, and for each service, to satisfy the virtual grid demand profiles. The resource modeller can be an entity using optimization or artificial intelligent techniques. However, the amount of resources should guarantee an E2E quality of experience for the customer, as specified in the service requirement for the future time of service. An example of a common resource requirement obtained from the resource modeller is represented as a matrix where an elements rᵢ is the amount of resources needed of a specific type of resources to satisfy any possible customer traffic profile. This can be done by first finding 462 a resource assignment for each potential Vgrid demand profile generated by step 460 using the historical resource requirement database 440 for different traffic demand profiles.

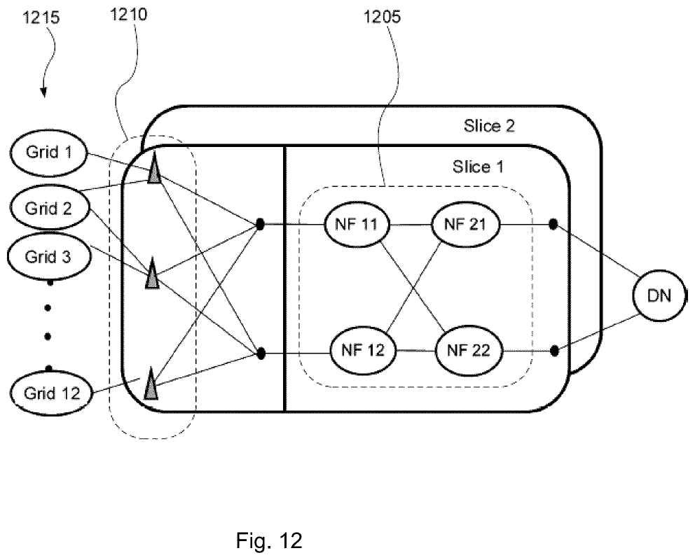

In an embodiment, instead of finding the resource requirement/profile for each Vgrid demand profile individually and then mapping the resultant resource profiles to a single common resource profile, a resource modeller may be designed to find a common resource requirement, i.e., a common set of resources directly for the virtual grid demand profiles created 460 previously using the input from historical learning described in step 435. This can be done using an optimizer or artificial intelligent techniques. In this case, although a resource assignment can be found for each demand profile using step 462 the objective is to find a minimum resource assignment common to the resources requirements needed for each demand profile in step 460 The minimum resource assignment requirement and an optimization technique to determine this assignment is described in detail, following the description of FIG. 12.

The amount of resources required from each domain can then be sent to associated domains, to be assigned to the service slice, and for the network slice to be provided for the customer. Accordingly, the resource modeller sends 466 an indication 467 of a minimum amount of resources to at least one network slice manager 470 to implement 475 the service slice according to the common set of resources. There are also methods to determine a minimum amount of resources using optimization techniques. Such minimization method is described in detail, following the description of Table 2. In some embodiments a method further includes the network slice manager sending a request to one or more domain managers for each of the plurality of domains to implement the service slice using a minimum amount of resources, as determined by a minimization method.

If historical data is not available when a customer request 450 is received, this network abstraction can be done after the network slice has been provisioned, by using an initial estimate of resources, and by collecting data on the same network slice, while it is in operation. During such an initial learning period, the resources could be overprovisioned. However, because a certain, adequate amount of data has been collected, the required resources can be further refined, and the allocated resources can be updated accordingly. This process can be done until it is confirmed that learning is completed for all participating demand profiles and all participating network states. After the learning stage, the operator can adjust the resources to satisfy the requirement and the operator can even modify the SLA to share the benefits with the customer.

It should be appreciated that while embodiments have been discussed in terms of virtual grids, the use of virtual grids and virtual grid demand profiles can be omitted in some embodiments. In which case grid demand profiles are used.

During a run-time phase of optimal resource assignment, in some embodiments, the functions performed can be similar in many respects to those of a provisioning phase as described above and shown in FIGS. 4a to 4b. Accordingly, the steps in block 400 and 444 can be reused in FIG. 5.

FIG. 5a to FIG. 5c represent a flow chart of functions used to optimize resource assignment during the run-time phase of a slice, according to some embodiments. It should be appreciated that FIG. 5 is divided into 5a, b, and c for space reasons. FIG. 5a shows an overall process, and FIGS. 5b and 5c show the details of a run time slice resource allocator 510.

Initially, the functions during a run-time phase can be similar to those of the provisioning phase. These include those functions identified with 405, 410, 420, 425, 430, 435, 440 and 460. Indeed in some embodiments, the run-time phase method illustrated in FIG. 5 can represent an ongoing (real time) enhancement to the provisioning methods discussed above. In other words, FIG. 5 illustrates revising virtual grid demand profiles based on ongoing monitoring of resource demand in the virtual grids and revising assigned resources to satisfy the revised virtual grid demand profiles. Once again, it should be appreciated that while embodiments have been discussed in terms of virtual grids, the use of virtual grids and virtual grid demand profiles can be omitted in some embodiments. In which case grid demand profiles are used.

In the case of monitoring 420 each grid for historical demand per service, a system can analyze 550 historical demand and correlation between grids, and then develop 555 correlated grids. Then it can proceed to analyzing 565 demand correlation and variation, and to determining 560 a future time interval T₂ for which to evaluate resource requirements.

In the case of monitoring 425 each grid for ongoing resource usage for each service type again, two examples methods can be utilized. In a first method, a system can learn 435, per service, a historical resource requirement for each grid, at a network state. Or in a second method, the system can determine 440 resource requirements for potential Vgrid demand profiles, and then proceed to finding 585 or 465 with resource modeller resource requirements to satisfy the demand profiles, as discussed below.

To determine 560 a future time window T₂ for which to evaluate resource requirements, past grid demand profiles, per service and per grid, can be monitored 570 over past time window T₁. This monitoring can be done in regular intervals or irregular time intervals within this time window. For example, during a past time duration T₁, several measurements of traffic demands for each grid could be obtained. These could be done at regular intervals within the T₁ duration. Then, this monitored data can be analyzed 565 to extract traffic-related statistics such as time variations, spatial and time correlations of the monitored traffic. The spatial correlation analysis may be done using the Cor-Grids determined using historical analysis. These statistics are used to predict one or more demand profiles that can be possible for the next T₂ time duration which is used for evaluating the resource requirement for the next T₂ interval Based on this analysis, the duration of a future time window T₂ over which resources are to be updated can be determined 560. In addition, one or more future demand profiles for the future time window T₂ can be predicted 575, taking into account time variations, spatial and time correlations of the monitored traffic. Accordingly, the next time window for monitoring will also be T₂. Also note that in some embodiments depending on the historical analysis of the demand variation, a fixed time window may be chosen, i.e. T₂=T₁.

Once predicted 575, the future demand profiles are converted 460 to predicted Vgrid demand profiles taking into account Vgrid information. This can be done, for example, by aggregating the traffic of geographic grids belonging to the same virtual grid.

A predicted virtual grid demand profile might contain irrelevant information acting as noise. For example, the traffic demand of a Vgrid might be of such a small value that this Vgrid could be combined with other Vgrids such as to simplify 580 the Vgrid demand profiles by forming multi-Vgrid demand profiles, with no impact on the total traffic originating from the Vgrid. The Vgrid demand profiles can be mapped to multi-virtual-grid demand profiles. When combining the Vgrids to form multi-Vgrids, the resource requirements of Vgrids can be averaged out to determine the resource requirement of the multi-Vgrids. Forming multi-Vgrid profiles is for simplification purposes only and in some embodiments may not be necessary.

A resource requirement satisfying the predicted virtual grid demand profiles can be evaluated 585 using one of the historical learning functions 435, 440 of virtual grid resource usage, as described above in the provisioning phase. A resource requirement evaluation can consider data from monitoring 590 and analyzing the performance and status of the network per service per virtual grid. Then the evaluated resource requirement across all domains satisfying the predicted virtual grid demand profiles can be assigned 592 to the associated domains along with the duration of a future time interval T₂.

As stated, some embodiments include determining a common set of resources to satisfy each virtual grid demand profile in the set of virtual grid demand profiles. In some embodiments, this can be performed by determining the amount of resources which satisfies the virtual grid demand profile with the highest resource cost. Different resources can have a different value to the network based on whether they are high in demand for services and total resource cost is evaluated using these values of individual resources. The resources could include computing resources (e.g. CPUs of different computing power), storage, energy and special infra-structure.

This determined amount is ideally the optimum amount of each resource type that is required for each of the virtual grid demand profiles, as this amount will satisfy each of the virtual grid demand profile in the set with minimum resource cost. Embodiments include a method to find this minimum resource profile associated with the minimum resource cost using optimization. However, in some situations this may not be the true minimum amounts because of the inaccuracy of the measurements, quantization and randomness of the demand changes.

Embodiments provide at least two frameworks, corresponding to two learning methods, to utilize historical learning in order to minimize resource for reservation for expected demand for a network slice, across multiple domains. These two historical learning methods can be used during a provisioning stage, during a run time stage, or both. A first learning method utilizes domain abstraction by historically learning the resource usage of the domains per service, per Vgrid, and per network state. A service may include a traffic flow with a specific QoS. In other words, this first learning method determines the resource usage per unit of traffic (RRUT) generated at a Vgrid, for different services at different network states for each domain for each possible traffic routing path that can be used in the network. The network state may include network loading at different network nodes or the used network features for the service. The second learning method utilizes a domain abstraction by historically learning the resource usage of the domains for all the traffic generated at each Vgrid at a given time, i.e. the resource usage for the Vgrid demand profile at a given time. A large number of these Vgrid profiles and their associated resource usage are collected, and quantization and classification methods are used to reduce the number of traffic profiles. Both learning method compiles and uses a large database with historical data. Instead of a database, a neural network may be trained for this purpose. Vgrids are formed by combining grids of the service area exhibiting similar resource usage, or similar path loss combinations. Vgrid formation can substantially simplify resource allocation, especially for large-scale networks. These embodiments also include functions to convert geographic grids into correlated grids, which can be utilized to convert a customer demand over a service area, into correlated grid-based demand profiles.

When a service provider uses an external NSEG to create a slice, it needs to obtain certain information, or an abstraction of the external NSEG, because external NSEG must be integrated with other NSEGs obtained from other service providers. An abstraction of an NSEG can be done considering one or more of:
the communication services and their capacities provided by the NSEG,
the resources provided by the NSEG,
the NSEG topology,
the resources required to provide the communication services,
the cost of resources

In the present disclosure, “network segment”, “network domain”, “domain”, and NSEG can be used interchangeably. In the following, various kinds of NSEGs are considered, and many ways to abstract an NSEG, using different types of communication services, are also considered.

When an external NSEG domain administration does not wish to expose its internal network details (e.g., resources and topology), the external NSEG should provide service capabilities or some kind of abstraction. In the present disclosure, such a NSEG is referred to as a “CLOSED” NSEG. In contrast, a NSEG that does provide its internal details is referred to as an “OPEN” NSEG.

As mentioned above, one way to make an abstraction of an NSEG is to obtain the communication services it can provide, and a knowledge of their cost and/or resource usage. Different communications services can require different amounts of resources. In an embodiment, to uniquely identify the services provided by an NSEG, the communication services can be categorized into several types, such that each type of communication services has a similar resource usage. In an embodiment, a type of communication service type can be identified by three components: traffic type, ingress port, and egress port.

A traffic type can be identified by specifying a range of parameters representing certain traffic characteristics, and requirements impacting usage of resources. The granularity of a parameter range representing a traffic type can be selected by a domain administrator to provide a finer or coarser abstraction of the system. For example, a traffic type can be one or more of
traffic belonging to a specific application, going from a set of ingress points to a set of egress points, where the application can include different sub-flows which might have to go through specific sets of network functions (NFs), i.e. NF chains;
traffic having specific requirements on QoS or QoS range (e.g., delay, jitter, packet loss rate);
traffic with a specific chain of NFs;
traffic having specific packet arrival statistics (regular, by bursts, etc.);
traffic having a specific packet size statistics and/or range;
traffic having a specific data rate and/or range.

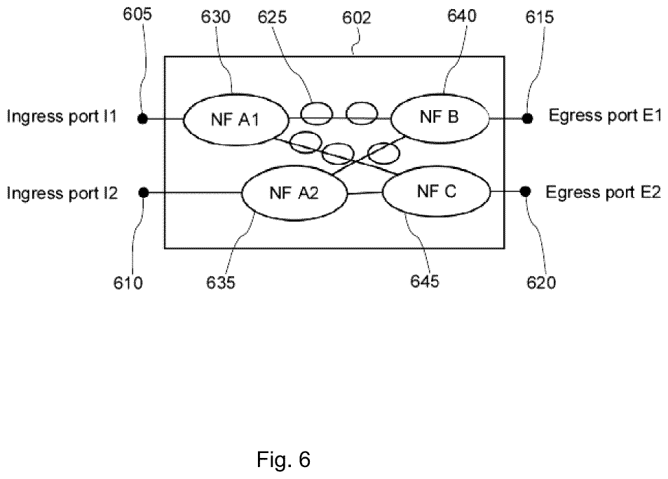

FIG. 6 illustrates an example of a network segment with two ingress ports, two egress ports, and multiple internal network functions, according to an embodiment. The network segment (NSEG) 602 has two ingress ports labelled ingress port I1 605 and ingress port I2 610, two egress ports labelled egress port E1 615 and egress port E2 620, and multiple internal network functions 625. In FIG. 6, it is assumed that network function NF A1 630 and NF A2 635 have similar functionalities; that NF B 640 and NF C 645 have different functionalities; and that other NFs 625 are generic routers. Therefore, for each of NF A1 630 and NF A2 635, the network segment 602 provides two distinct NF chains. For NF A1 630, the two chains are:
NF A1→NF B
NF A1→NF C
   and for NF A2 635, the two chains are:
NF A2→NF B
NF A2→NF C

This makes for a total of four distinct paths: A1-B, A1-C, A2-B, and A2-C; and each path can serve one of the NF chains. Therefore, this NSEG 602 contributes to four different communication service type (CST) characteristics.

In another example, one traffic has a delay having 4 different ranges and another traffic has packet arrival statistics having 3 different types, then a total of 48 different CSTs can be provided by this segment 602, i.e.:

$$Number of different CSTs = ( number of paths and NF chains ) \times ( number of delay ranges ) \times ( number of packet arrival types )$$

$$Number of different CSTs = ( 4 paths and chains ) \times ( 4 delay ranges ) \times ( 3 packet arrival types )$$

$$Number of different CSTs = 48$$

In an embodiment, a RAN NSEG can be abstracted as follows. When a RAN segment is considered to be a separate administrative domain, the geographic area can be divided into small grids which can be used as ingress ports for uplinks, or egress points for downlinks.

In an embodiment, an evaluation of the resource requirement to satisfy expected traffic demand profiles that are generated based on service requirement can be carried out in two stages, as follows. A first stage can be an abstraction of individual domain characteristics including historical learning of resource usage (historical learning stage), as illustrated in FIG. 4 (405, 410, 420, 425, 430, 435, 440). A second stage can be to determine the minimum resources needed from each domain, to satisfy the customer's service requirement (resource assignment stage). As an example, the first stage can be provided by a RAN NSEG as follows.

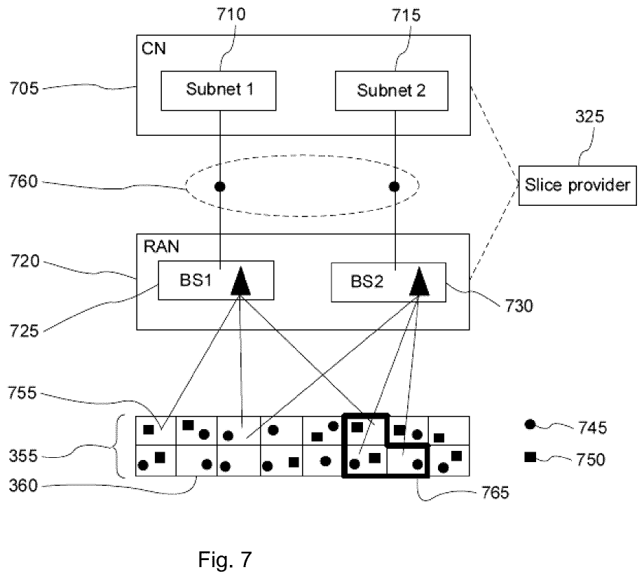

FIG. 7 illustrates how a RAN NSEG can be abstracted by using, as ingress or egress ports, grids defined by the amount of resources they require, according to an embodiment. A core network 705 can include sub-networks subnet 1 (710) and subnet 2 (715), and a radio access network 720 can include a base station BS1 725 and a base station BS2 730. A service area 355 can be divided into a plurality of grids 360 in which users 745 of slice A and users 750 of slice B are located. These grids operate as ingress ports for uplinks and/or egress ports for downlinks on the service area side 755 of the RAN. There can also be ports 760 for uplinks and/or downlinks on the CN side.

Functions of a historical learning stage for a NSEG are described below using RAN domain as an example. These are the initial functions showed in FIG. 4 (405, 410, 420, 425, 430, 435, 440, 445). Although RAN uplinks are used in this example, the same is also applicable to another domain.

Initially, the input (ingress) ports and output (egress) ports of the domain under consideration can be identified. For a RAN uplink (UL), an ingress point can be a mobile terminal. Because the ports' locations can uniquely identify the resource requirements, the service area 355 is divided to create 405 equally sized grids 360, each one representing an ingress point 755 of the RAN. The grid size depends on several factors such as the accuracy the RAN required by the operator for the resource assignment, the wireless transmission technology being used, and how accurately a user's location can be determined. For a downlink (DL), each base station 725, 730 becomes an ingress port while grids 360 of the service area 355 become egress ports. For other domains, the input ports are considered as ingress ports, based on their location.

To develop 410 a Vgrid, grids 360 of the service area 355 are combined based on similarity of resource usage, path loss and/or service. The combination of grids 360 results in a virtual grid (Vgrid) 765.

For a RAN domain, each Vgrid 765 can be developed 410 by combining grids 360 receiving a similar signal strength from a few of the strongest base stations 725, 730. For other domains, input or output ports can be represented by virtual ingress ports if the services originating or terminating at those ports exhibit characteristics similar to those of the external world, such as similar geographic proximity or similar delay for participating ingress/egress ports (from/to associated external nodes).

Then, for a given communication type service (CST) and a given time duration, historical grid-based demand can be monitored 420, as well as the associated grid-based resource usage 425.

Then, a grid-based traffic demand 420 and the associated resource usage 425 can be mapped 430 to a Vgrid-based traffic demand and an associated Vgrid-based resource usage, using Vgrid conversion information available from Vgrid development 410. To make this conversion, the grid-based traffic demand and associated grid-based resource usage per service type, for geographic grids belonging to the same virtual grid, are added together. This can be done by a RAN manager monitoring the amount of resources used by a CST, for a specific amount of traffic originating from different grids. In order to identify the resource usage statistics, this can be monitored for regular time intervals.

When an external service provider is using a RAN segment, it might require information about the capability of the RAN segment in terms of providing different types of CSTs. For this purpose, any network providing a network slice to a customer can learn the resource usage at each grid, using historical resource usage statistics collected during the operation of the previously provided slices. This can be to obtain any of resource details, service details, and resource usage statistics, at the load level of a given service, and to make an abstraction of the system. This analysis can be done by individual NSEG OAMs or by a central OAM. In the latter case, the central OAM can send a request to the NSEG OAMs to monitor the required usage data, and to report it to the central OAM. The central OAM can then analyze the data to obtain the resource requirements 465. For this purpose, an embodiment can make use of two methods: finding 435 historical resource requirements for each virtual grid, and obtaining 440 resource requirements for different virtual grid demand profiles. These methods are further described below.

To find 435 historical resource requirements for each virtual grid, a resource requirement per unit of traffic (RRUT) for each CST can be determined. A RRUT depends on a grid's location on a service area, as well as other factors. For example, a RRUT can depend on the path of traffic flow, which is itself based on other traffic existing in the network. Therefore, traffic originating from the same location, for the same service type, might go through different paths at different times. In addition, depending on network loading, the resource usage for a given service at a given location can vary. For example, depending on interference, base station resources can be used differently. For these instances, the RRUT can be evaluated using an average resource usage. Therefore, it might be required to determine the resource requirement for each service type provided at each virtual grid, for a given network state (e.g., network load, demand profile, scheduling scheme). Network state parameters can be determined from a state dependent function with statistical variations, reflecting usage of a resource for a given network state. However, it is often the case that given a fixed network state, the resource usage at a given location should be constant and for a given grid, it should be sufficiently stable. The network state of neighboring areas can be sufficient for this purpose.

A network state can be defined in different ways, for example, in terms of loading of the neighboring base stations, or of demand distribution across a grid. If defined in terms of loading of neighboring base stations much finer levels of network states can be obtained, but this can create a large number of states and produce significant noise. Loading of neighboring base stations can be determined from analyzing the demand from overlapping areas of neighboring base stations, from non-overlapping areas of neighboring base stations, from overlapping areas shared by neighboring base stations, and/or from non-overlapping areas shared by neighboring base stations. The loading of 2^{nd} degree neighbors (excluding 1^{st} degree neighbors) can also be considered. These can be aggregated as a single number, but if further accuracy is needed, they can be aggregated as two numbers: one for loading overlapping areas, and another for loading non-overlapping areas. To reduce the total number of network states, the final loading numbers can be classified. An overlapping area can be an aggregation of areas where the difference in signal strength between two base stations is within a small range (e.g., 3 dB).

To obtain 440 resource requirements for different virtual grid demand profiles, a resource usage for given traffic profiles can be stored in a large database. Then, a resource requirement can be obtained from this database. However, the required capacity of such a database might be too large to be practical for an implementation. During a monitoring stage, the resource requirement used for a given demand profile of a grid can be determined. Because there are many combinations of traffic demands, a classification (e.g., quantization) of the demand profiles can be required to limit their number. In an embodiment, this can be done by an AI unit or by quantization.

By observing historical traffic demand, the traffic demand of each grid can be analyzed, and grids can be combined as necessary to obtain 445 correlated grids (Cor-Grid), such that each correlated grid is a combination of multiple grids.

After Cor-Grid have been prepared, a domain is ready to allocate resources to a slice considering historical analysis, either during a provisioning phase or a run-time phase. The historical analysis can be done by the NSEG OAM or by a central OAM. In the latter case, the central OAM can send a request to the NSEG OAM to monitor the required resource usage data, and to report it to the central OAM, which can analyze the data to obtain the required resource requirement.

The above describes how historical learning is applicable to RAN UL transmissions. In this case, the geographic grids represent the input ports of the RAN domain and the grids showing similar resource usage are combined as Vgrids. In addition, for the UL, the base stations represent the egress ports. For the DL, the geographic grids and the base stations can represent the egress ports and ingress ports, respectively. The grids can be combined if they have similar resource usage for a given service, or if they are using location proximity to the connecting nodes(s) in the external NSEGs. For domains other than RAN, two or more input or output grids can be combined to form Vgrids if they exhibit the same service capability for an external customer. Changing the grids within a group of Vgrids would not alter resource usage of a traffic type.

In an embodiment, an NSEG can be abstracted using, for example, its service capability. Vgrids enabling an abstraction of RAN and other domains for UL and DL, as well as various communication service types, can also be obtained. The concept of Vgrids facilitates network slice provisioning by encapsulating demand and/or resource requirement information.

There are several ways that a slice customer such as a vertical would provide service requirements to a network operator for a given time period/zone. The following are examples of different service level agreements (SLA).

In a first kind of SLA, SLA1, a customer can provide an indication of traffic demand for a large region, such as a city described using general geographic maps.

An example of an indication for SLA1 is a statistical distribution of UEs (e.g., uniform distribution across the region) with service usage statistics of an average user, a per user peak rate, and an average user's data rate statistics.

Another example of an indication for SLA1 is the total number of UEs or total traffic (e.g., aggregated data rate), provided by a customer, that should be supported in the region (per each region). When the total amount of traffic (e.g. user equipment, UE) is given without a traffic distribution within a region, the network provider has to assume a certain worst case scenario, and provide a slice accordingly, which can be overestimated, and the customer might have to pay a higher price. However, the network provider can learn the statistics and/or behaviors and derive a distribution using location statistics of traffic generation. In addition, a network provider can modify the SLA to a certain distribution model, to provide an advantage to the customer.

In a second kind of SLA, SLA2, the customer provides the traffic demand for a BS or traffic area (TA) identified by the network operator. Instead of geographic regions defined by grids, the vertical provides similar information as in SLA1 for each BS or TA specified by the provider. This can be for a knowledgeable customer such as an operator.

In a third kind of SLA, SLA3, the slice customer provides the traffic demand for each grid in the service area and the network provider divides the service area 355 into smaller grids 360 (e.g., 5×5 m²). Within a BS coverage area, there can be multiple grids. The details of these grids, as marked on a map, can be given to the customer. The customer provides the demand for each grid 360, as a statistical distribution of UEs or a total number of UEs expected in a given time or time interval, etc.

Because the customer might not have a clear idea of the traffic demand and might not be aware of the demands in smaller areas defined by the network operator, the most likely scenario among the above three SLAs, is SLA1.

In an embodiment where a customer provides any type of service requirement, this requirement can be converted to a statistical traffic demand distribution over a geographic area. Therefore, the above customer service requirements can be considered as a statistical distribution of a traffic demand. For example, when the user distribution is provided with an indication of per user traffic demand, it can be converted to a traffic demand distribution. If the user's traffic demands are not given, the provider can use an average user's traffic demand for the services the user required and use that to convert the requirement to a traffic demand distribution over the geographic area. Alternatively, the provider can use the information for per user traffic demands using historical learning, i.e. by monitoring general user traffic generations in the past and analyzing them. By dividing the geographic area into equal size geographic grids (e.g. 10 m×10 m, or 5 m×5 m) it can be translated to a grid-based traffic demand distribution. This translation can be done either with a simulation or be derived mathematically.

In a simulation approach, the users are dropped according to statistics provided over the service area. Because each grid 360 is formed with the same size, this can be done according to the statistics provided. Then, the demand for each grid can be observed and logged. Next, the traffic demand for a Vgrid is evaluated, by aggregating the traffic demands of the grids belonging to that Vgrid. A Vgrid traffic demand profile for the geographic area can be expressed as a vector where each entry of the vector represents the traffic demand of a Vgrid. Then, another set of users can be dropped using the same distribution with a different random seed, and a second Vgrid traffic demand profile can be obtained. This process can be repeated to obtain a large number of Vgrid traffic demand profiles.

A grid demand profile or a Vgrid demand profile is not a fixed demand profile. Due to the statistical nature of the demand, a large number of traffic demand profiles can be prepared.

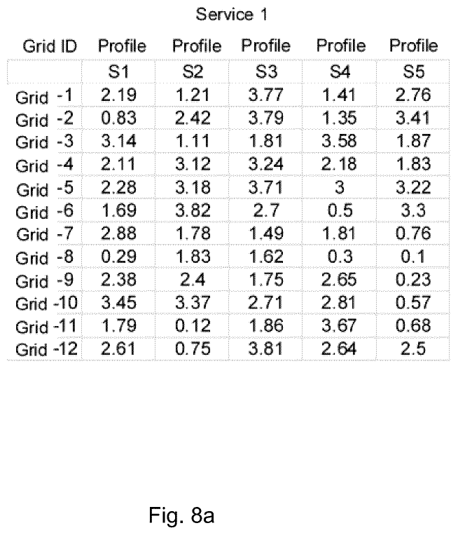

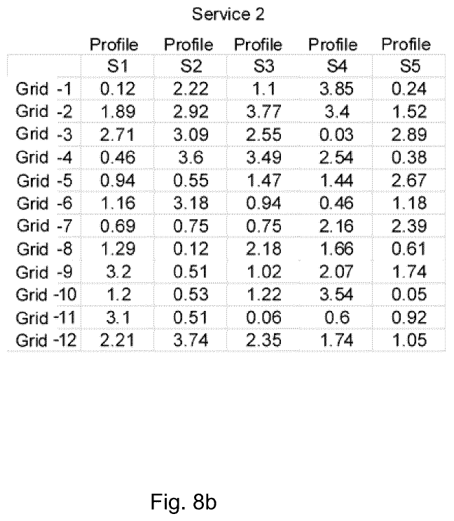

FIG. 8a illustrates five traffic demand profiles for a service called “service 1”, according to an embodiment. Each demand profile, e.g. Profile S1 to Profile S5, for service 1, is based on a service area 355 divided into twelve grids 360: Grid 1 to Grid 12. Each number in the table represents the demand of a grid at a moment in time.

FIG. 8b illustrates five traffic demand profiles for a service called “service 2”, according to an embodiment. Each demand profile, e.g. also called Profile S1 to Profile S5, for service 2, is based on a service area 355 divided into the same twelve grids 360 as in FIG. 8a: Grid 1 to Grid 12. Each number in the table represents the demand of a grid at a moment in time.

In an embodiment, if the customer can express the geographic demand variations according to a known statistical distribution, such as a uniform distribution or a clustered distribution, then the conversion of an SLA 1 to a grid-based traffic demand profile can be done mathematically. A traffic profiles can be generated based on the given traffic statistics by deriving traffic demand for each grid or each Vgrid. If the spatial demand correlation has already been analyzed in a particular area for a given service, correlated traffic profiles can be generated mathematically by deriving traffic demand for each Cor-Grid. For this purpose the correlation values among the Cor-Grids obtained during historical analysis can be used.

If the customer provides the total number of users, without indicating how the users are distributed over the service area 355, the network provider has to assume a certain worst-case scenario and provide a slice accordingly. As a worst case, the total number of users can be from a smaller area of the service area 355 (e.g., belonging to the same grid). In order to prepare for such a situation, the network provider has to use a large number of resources unnecessarily and the SLA must specify some conditions where that such a situation cannot be addressed. In addition, the customer may have to pay a higher price. However, the network provider can learn the statistics and/or behaviors and derive a distribution using location statistics of traffic generation. In addition, the network provider can modify the SLA to a certain distribution model, to provide a benefit to the customer.

To update network slice resources during run time, the traffic demand over the next time interval where resources are allocated should be predicted.

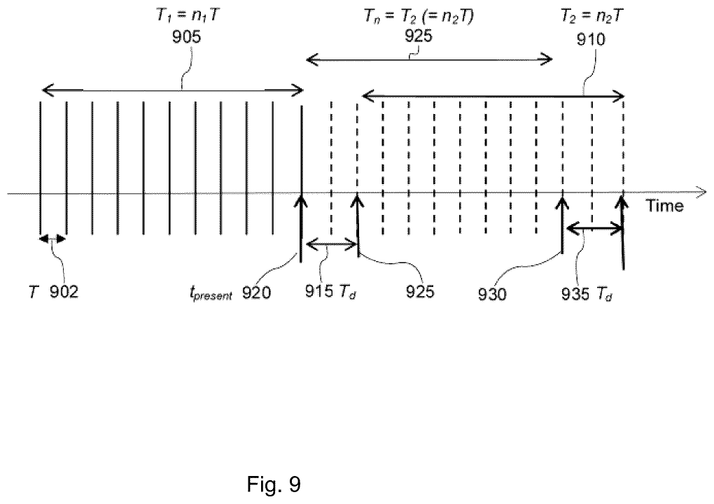

FIG. 9 is a graph illustrating the time intervals used to monitor traffic, and to predict resource allocations, according to an embodiment.

Initially, traffic demand statistics for each grid, and for each service (slice), can be monitored regularly. Traffic statistics such as time correlations and spatial correlations can be extracted from the latest preceding monitoring interval 905. The duration of a monitoring interval can be denoted as Tᵢ, where Tᵢ=. . . , T₋₂, T₋₁, T₀, up to T₁, with T₁ 905 being the latest preceding monitoring interval. Each monitoring interval Tᵢ, including T₁ 905, can be subdivided into a multiple nᵢ of a minimal time interval T 902:

$${T}_{i} = {n}_{i} T$$

Then, a demand profile for each monitoring interval Tᵢ can be generated, and each domain can report its performance during each monitoring interval Tᵢ.

Then, a decision about future resources and policies that are to be used by a domain at a future interval T₂ can be made by considering the traffic profile of the latest monitoring interval T₁, and feedback can be received regarding domain performance at times tⱼ (tⱼ=t₀, t₁, t₂, . . . , tₚᵣₑₛₑₙₜ), within the monitoring interval T₁, i.e., at times:

$${t}_{0} = - {n}_{1} T$$

$${t}_{1} = - {n}_{1} T + T$$

$${t}_{2} = - {n}_{1} T + 2 T$$

$${t}_{3} = - {n}_{1} T + 3 T$$

$$⋯$$

$${t}_{present - 3} = - {n}_{1} T + ( {n}_{1} - 3 ) T$$

$${t}_{present - 2} = - {n}_{1} T + ( {n}_{1} - 2 ) T$$

$${t}_{present - 1} = - {n}_{1} T + ( {n}_{1} - 1 ) T = - T$$

$${t}_{present} = 0$$

where:
t₀ is the time at which the latest monitoring interval T₁ begins,
T 902 is the minimal time interval of a traffic profile,
n₁ is the number traffic profile, and of time intervals T, within monitoring interval T₁, and
tₚᵣₑₛₑₙₜ 920 is the time at which the monitoring interval T₁ 905 ends.

A future interval for which resource allocation is to be predicted, can be time interval T₂ 910. For a CN segment or TN segment, a traffic profile refers to the traffic load at each ingress point.

Before executing 925a decision to allocate resources and policies during time interval T₂ 910, a time delay T_{d} 915, starting at tₚᵣₑₛₑₙₜ 920 can be required, because the slices and the network segments must be updated with the decision of the resource assignment. The duration of interval T₂ depends on how fast the traffic is changing over time.

Before making a subsequent decision, a certain interval of time Tₙ 925 must pass. In an embodiment, it can be Tₙ=T₂=n₂T (i.e., n₂ times interval T). The next decision interval 935 can start at time tₚᵣₑₛₑₙₜ+Tₙ (930), and also last for T_{d}., after which the next resource allocation can be executed. To determine the value for n₂ the variability of traffic during the last n₁ traffic profiles can be considered.

Then, a method according to an embodiment can determine resource assignments and policies for the next interval T₂ and sending the assignments to individual segments. The interval T₂ being the time interval before starting the resource allocation and policy period.

The set of traffic demands for the last n₁ traffic profiles from each grid can be obtained practically by monitoring the ingress traffic from different locations. Using these statistics, the time correlation of the demands in each grid 360, and the spatial correlation among the grids 360 located in close proximity to each other can be determined.

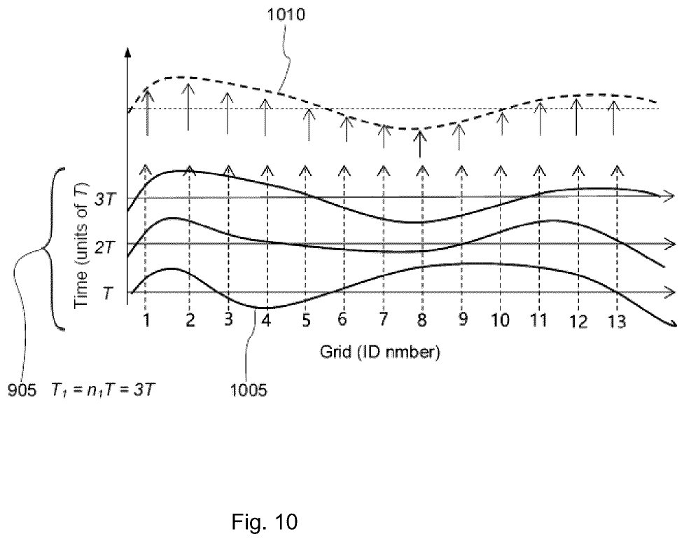

FIG. 10 illustrates for each of thirteen grids, a future traffic demand profile, as predicted by a time series analysis taking into account both time correlation and spatial correlation of three traffic demand profiles, according to an embodiment. The monitoring time interval 905 has a duration of 3 T. By using a time series analysis of the past traffic profiles 1005, a future traffic profile 1010 can be predicted, taking into account both time correlation and spatial correlation. Although only one predicted traffic demand profile is shown in FIG. 10 there can be more. For validation purposes, any prediction scheme developed for similar prediction scenarios can be used, including scheme based on an auto-regression model. The statistics of the past variations of the demands in each grid 360 can be analyzed, and the future values, considering traffic variations, and time and spatial correlation (among grids based on the distance between grids) can be determined. Once the expected traffic demand profiles are generated, the minimum resource cost allocation satisfying them can be found as explained in the following.

After converting the service requirement to a set of grid-based or Vgrid-based expected traffic demand profiles (ETDPs) according to an embodiment, the resource requirement for each grid-based or Vgrid-based ETDP can be evaluated. At least two methods can be used, and a selection can depend on what historical information is available. These are finding 435 historical resource requirements for each Vgrid and obtaining 440 resource requirements for different Vgrid demand profiles. Functionality is respectively provided by preparing demand profiles as multi-virtual-bin profiles & finding resource profiles, and by finding resource assignment to match each Vgrid demand profile.

Finding 435 historical resource requirements for each Vgrid can be difficult, because a given grid can be served using different paths or features. When the RRUT is available (as the output of 435), a given grid/Vgrid-based demand profile ca be evaluated using an optimization method or an artificial intelligence (AI) module. Note that although an optimization algorithm can be developed for multi-traffic profiles, it can also work for a single traffic profile scenario, by setting the number of traffic profiles to one. Since the above optimization method can be a time-consuming scheme, an AI based functional block to prepare demand profiles as multi-virtual-bin profiles & find resource profiles can be used for this purpose. The AI scheme can be a distributed scheme where each RAN node is running an AI scheme.

Because a database of direct mapping from a demand profile to resource requirement is available, a minimum resource usage can be found by determining 440 resource requirements for different demand profiles of a Vgrid. Since a database can have quantized levels of demands, a method that includes an interpolation step can be required to assess the resource requirement accurately.

Because expected traffic demand profiles do not have to be served simultaneously (only one traffic profile is present at a time), the resource requirement is not a simple aggregation of the resource requirements for each traffic profile. Also, it is not the largest resource used across all the traffic profiles. This is because a given traffic profile can be served by different types of resources, by changing the paths (e.g., changing the serving BS) used for the users located in a given grid. This is also the reason why simulation approaches of the prior art, which use a large number of user drops, cannot be used to find the minimum resource requirement for all the drops. The following describes an example of resource requirement evaluation using Monte Carlo simulations, followed by two proposed schemes: the first scheme based on optimization; and the second scheme based on an AI.

To find the resource requirement that satisfies a certain user distribution, a direct answer can be to drop the users according to the provided user distribution and carry out a large number of simulations to find the amount of required resources. However, this would not give an optimal resource requirement. The following is a method that a network provider can use to evaluate the resource requirements using a simulation.

Initially, the users can be dropped in the network according to the distribution provided by the customers (e.g., SLA). As users are added to the network, the best paths (e.g., the paths with minimum allocated resources) for the users can be selected. When all the participating users have been dropped, the resources used in each domain can be evaluated. The resource requirement for the first drop of users can be represented by a vector R₁, where each component of the vector represents the amount of resources needed from a particular resource type. For example, if there are two types of resources, a vector R₁ can be defined as R₁=[r₁₁, r₁₂], where component r₁₁ represents the amount of a first resource and component r₁₂ represents the amount required for a second resource. The first index of a component r identifies a drop of users, and the second index of r represents a particular resource.

Then, a new set of users can be dropped again as per the distribution provided by the customer. Another resource vector R₂=[r₂₁, r₂₂] is obtained.

Then, in order to satisfy the two user drops, a resource allocation of at least:

$$R = [ {r}_{1} , {r}_{2} ]$$

is required, where r₁ is the maximum amount needed of the first type of resource:

$${r}_{1} = max ( {r}_{11} , {r}_{21} )$$

and r₂ is the maximum amount needed of the second type of resource:

$${r}_{2} = max ( {r}_{12} , {r}_{22} )$$

Because the two user drops do not exist simultaneously, a resource allocation R=[r₁, r₂] as above, which is not the summation of the resource requirement for the individual traffic profiles, can satisfy the two user drops.

Similarly, there can be a large number of user drops and the above steps can be repeated to find a resource allocation satisfying all the participating user drops.

Finally, a central OAM has to inform all the domains of the allocated resources for the slice, and the associated resource policies. At run-time, resource allocation to individual communication services can be done by each domain. The policies sent to each domain can include the information required to serve user traffic of the slice. This can include, for example, the CSTs, the capacities and requirements each domain should provide, and SLA information, such as what to do when traffic is increased beyond what is specified in the SLA (e.g., packet drop, session rejection, monitoring requirement, feedback, and charging information).

Then, if multiple slices are provided by the slice provider, and if the resources are shared among the slices, the total amount of resources needed for all the participating slices can also be found by including the traffic profiles of the other slices in above steps. In this case, a dynamic resource allocation for each slice needs to be done by each domain.

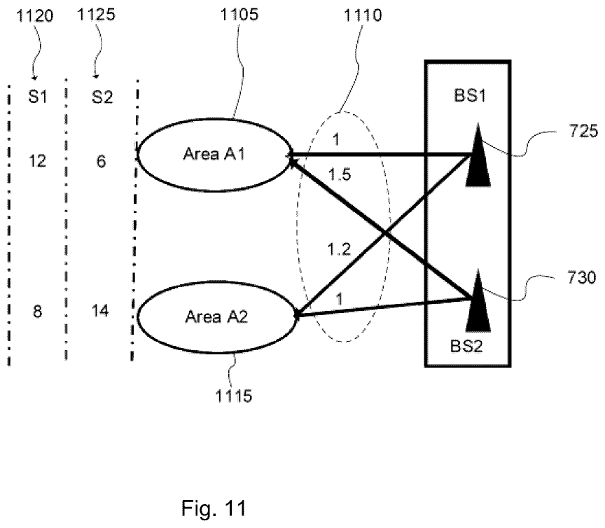

FIG. 11 illustrates two possible user distributions (traffic profiles), S1 and S2, each one with a certain number of users in each of two service areas, service area A1 and service area A2, as well the base stations serving them and the amount of resources being served, according to an embodiment.

A user in area A1 1105 can be served 1110 either by BS1 725 with 1 unit of resource, or by BS2 730 with 1.5 unit of resources. Also, a user in area A2 1115 can be served either by BS1 725 with 1.2 units of resources, or by BS 2 730 with 1 units of resources. If only traffic profile S1 1120 is considered, the minimum amount of resources required to support S1 is 12 units of resources from BS1, and 8 units of resources from BS2. Similarly, to support traffic profile S2 1125, 6 units of resources are needed from BS1, and 14 from BS2.

Hence, if a simulation-based method is used for resource evaluations, and a system must support the two traffic profiles S1 and S2, the system would need 12 units of resources from BS1 (the maximum of 12 and 6), and 14 units of resources from BS2 (the maximum of 8 and 14). Table 1 shows how many resources are required for each of S1 and S2, and how many are required to cover both S1 and S2 successively, for the example in FIG. 11.

TABLE 1
Resource requirement for the example in FIG. 11

| | Resources | Resources | Resource |
|---|---|---|---|
| | for S1 | for S2 | for S1 & S2 |
| BS1 resources | 12 | 6 | 12 |
| BS2 resources | 8 | 14 | 14 |

A better resource allocation mechanism for the traffic profiles S1 and S2 can be as follows. When the resources for traffic profile S2 are to be evaluated, instead of ignoring the resources allocated to traffic profile S1, the resource requirement can be found taking into account both requirements. For example, the minimum resource requirement for the traffic profile S1 is (12, 8), while for traffic profile S2, it is (6, 14). However, 12 resources from BS1 have already been allocated to traffic profile S1, 6 of which are not used in traffic profile S2. Therefore, 5 users of traffic profile S2 located in area A2 could be assigned to BS1 for these unused 6 resources (5×1.2=6), although it is not the minimum resource allocation for traffic profile S2. This means that BS2 should only support 9 users from area A2 with 9 of its resources, as shown in Table 2 (second row). This could minimize the total amount of resources needed to support both traffic profiles, from 26 units of resources, to 21. This is because both traffic profiles do not have to be supported simultaneously, and the requirement is to be able to support them at different times. Similarly, if resources are first assigned for the S2 distribution, and then for the S1 distribution, the total allocated resources can be reduced from 26 to 22, as shown in the third row of Table 2. This gain of resource usage happens by jointly considering two traffic profiles, and it is achieved by using an optimization method to solve multi-traffic profile resource minimization problem.

TABLE 2
The joint consideration of resource requirements for multiple
traffic profiles minimizes resources

| | BS1 | BS2 | Total |
|---|---|---|---|
| | resources | resources | resources |
| Scheme 1: Minimizing resources for | 12 | 14 | 26 |
| each traffic profile individually | | | |
| Scheme 2 (Joint consideration): | 12 | 9 | 21 |
| Moving S2 traffic of 5 users in area | | | |
| A2, to BS1 | | | |
| Scheme 3 (Joint consideration): | 8 | 14 | 22 |
| Moving S1 traffic of 4 users in grid | | | |
| A1 to BS2 | | | |

An optimization problem can be to minimize the amount of resources allocated to multiple network slices, such that the allocated resources satisfy the customers' service demand.

FIG. 12 illustrates a network including a RAN, a TN, and a CN, and grids of a service area, according to an embodiment.

A geographic area A within a maximum area R² (A ⊂ R²) is to be served by a set of network slices, each slice identified by an index s such that each s identifies a slice of the set S of slice indices (s∈ [symbol] ), and area A is covered by a set [symbol] of base stations indices, each base station identified by an index b such that each b identifies one base station of the set B of base station indices (b∈B).

The CN includes a set of virtual network functions (NF), each NF identified by an index f such that each f identifies one NF of the set [symbol] of virtual NF indices (f∈ [symbol] ). For each NF f, a number M_{f} of resource types is required. An embodiment can include a set of resource types, where each resource type is identified by an index m such that each m identifies one resource type from a set [symbol] of resource type indices (m∈M). It can be assumed that the number M_{f} of resource types required to deploy NF f, is the number of different types of resources in the set M of resource type indices (i.e., the cardinality of set M):
M_{f}=|MC|

Typical examples of the resources needed for the virtual NFs are computation, memory, storage, and bandwidth, while for base stations, it is bandwidth. The resource type “bandwidth”, which can be identified as M_{b}, is included for any base station (i.e., M_{b}=1 ∀ b∈B). However, although for slice provisioning, the bandwidth resource type is the most common resource of a BSs, the framework is general in the sense that multiple resources can be provisioned at the base stations similarly to virtual network functions. Therefore, in the general case, the term “service node” can be used to refer to the virtual network functions, and to the base stations (i.e., NFs and BSs).

The amount of resource type m, that is available at a service node v, where v identifies a service node from a set V of service nodes indices (i.e., v∈V), can be denoted by Cₘ^{v}, where the set V includes the base stations indices and the network function indices, i.e., V=B ∪ [symbol] .

Similarly, the capacity of a link is denoted by Cₗ_{ᵢ₋ⱼ}, where lᵢ₋ⱼ denotes the link connecting node i and node j and lᵢ₋ⱼ belongs to a set [symbol] of links i.e.: lᵢ₋ⱼ∈ [symbol] .

It can be assumed that the NFs and the links are already deployed, and that the network slices use the same service function chains. Although the downlink in which the flows of the network slices originate from the source node DN and terminate at the geographic grids is considered, the framework is also applicable to the uplink.

The geographic area A is divided into G regular equal size grids, G being the cardinality of the set [symbol] of grids: G=| [symbol] |. Each grid [symbol] _{g} can be indexed by g. A network slice provider can map a customer's service demand (i.e., a requirement) into a set of expected traffic demand profiles (i.e., grid-based traffic demands) by generating Tₚ traffic profiles for each service.

If d_{g}^{s,t} is the traffic demand of a traffic profile t, at a grid g, for network slice s, then a service profile can be given by a set Dₛ^{t} of traffic profiles d_{g}^{s,t}:

$${D}_{s}^{t} = [ {d}_{1}^{s , t} , {d}_{2}^{s , t} , … , {d}_{G}^{s , t} ]$$

where s identifies a slice of a set S of slice indices (s∈ [symbol] ), and t identifies a traffic profile from 1 to Tₚ (t=1, 2, . . . , Tₚ).

In embodiments, a backslash notation means “excluding”, such that “ [symbol] \b” means set [symbol] excluding element b.

If P_{gb} is the received power level from base station b at grid g, and P_{N} is the noise power, then the signal-to-interference ratio γ_{gb} at grid g, when it is connected to base station b, can be given by

$${γ}_{gb} = \frac{{P}_{gb}}{{P}_{N} + {\sum }_{q ∈ B ∖ b} {P}_{gq}}$$

As for the spectral efficiency β_{gb} at grid g, when served by base station b, it is given in bits/sec/Hz by

$${β}_{gb} = log ( 1 + {γ}_{gb} )$$

In an embodiment, the amount of traffic in a network slice s with a traffic profile t, flowing from node i to node j, can be denoted by x_{i,j}^{s,t}.

Also, the set of the nodes, including grids, base stations, network functions, ingress points of the CN, and egress points of the CN, that are connected to the outward edges of a node n, can be denoted by Lₒᵤₜ(n).

Then in terms of throughput over the area A, a service requirement can be captured by the traffic profiles Dₛ^{t}, for any slice indexed by s of a set [symbol] , and for any t from one 1 to the number Tₚ of traffic profiles, (∀ s∈ [symbol] , t=1, 2, . . . , Tₚ).

The total amount of traffic, flowing from all participating base stations to each grid, should satisfy the traffic demand d_{g}^{s,t} of the network slice s at that grid g, which is:

$${\sum }_{b ∈ B} {x}_{b , g}^{s , t} = {d}_{g}^{s , t} \qquad C1$$

$$∀ g ∈ G$$

$$∀ s ∈ S$$

$$t = 1 , 2 , … , {T}_{p}$$

The amount of resource of type m allocated to network slice s at the service node v can be denoted by w_{m,s}^{v} where v identifies any base station or network function v∈V, or:
v∈( [symbol] ∪ [symbol] )
   Due to the limitation in the available resources, the total resource usage of the network slices cannot exceed the amount of available resources Cₘ^{v} (constraint) at a service node v. This constraint can be written as

$${\sum }_{s ∈ S} {w}_{m , s}^{v} \leq {C}_{m}^{v} \qquad C2$$

$$∀ m ∈ {M}_{v}$$

$$v ∈ ( B ⋃ F )$$

where m identifies one resource type from a set [symbol] ᵥ of resource types for node v.

Furthermore, the resources allocated to each network slice at the NFs and BSs must support the traffic flowing through the NFs and BSs. That is

$${\sum }_{j ∈ {L}_{out} ( f )} {x}_{v , j}^{s , t} {u}_{v , j}^{m , s} \leq {w}_{m , s}^{v} \qquad C3$$

$$∀ f ∈ F$$

$$∀ m ∈ {M}_{v}$$

$$∀ s ∈ S$$

$$t = 1 , 2 , … , {T}_{p}$$

Here, u_{v,j}^{m,s} is the amount of resource type m at the service node v needed to process a one unit of network slice s traffic flowing to node j. The resource usage per a unit of traffic, i.e., u_{v,j}^{m,s}, also depends on the node to which the traffic is flowing to. For example, different grids use different amount of base station resources (e.g., bandwidth) due to the differences in signal strengths at these grids.

For the transport links, the total capacity allocated to the network slices cannot exceed the link capacity. This constraint can be written as

$${\sum }_{s ∈ S} {c}_{s}^{{l}_{i - j}} \leq {C}_{{l}_{i - j}} \qquad C4$$

$${l}_{i - j} ∈ L$$

where cₛ^{l}^{ᵢ₋ⱼ} is the capacity of the link lᵢ₋ⱼ, that is allocated to network slice s.

Also, the allocated capacity cₛ^{l}^{ᵢ₋ⱼ} must support the traffic of the network slice s flowing in the link lᵢ₋ⱼ. This constraint can be expressed as follows:

$${x}_{i , j}^{s , t} \leq {c}_{s}^{{l}_{i - j}} , ∀ s ∈ S , t = 1 , 2 , … , {T}_{p} \qquad C5$$

$$∀ s ∈ S$$

$$t = 1 , 2 , … , {T}_{p}$$

In an embodiment, it can be assumed that inter-arrival times of the packets and the service times are exponentially distributed and that the packets arrive independently at the service nodes.

The set of the network paths p_{g} from grid g to the data network can be denoted by [symbol] _{g} (p_{g}∈ [symbol] _{g}). Each path p_{g} can itself be identified by a set of ordered nodes given by:

$${p}_{g} = \{ g , b , ig , {f}_{1} , {f}_{2} , eg \}$$

where f₁∈ [symbol] , f₂∈ [symbol] ,
ig denote the ingress port of the CN, and
eg denote the egress port of the CN.

The average end-to-end (E2E) delay of grid g traffic over all paths cannot exceed the required delay Δₛ:

$$\frac{L}{{β}_{gb} {w}_{bw , s}^{b} - {x}_{b , g}^{s , t}} + {\sum }_{i} {\sum }_{j ∈ {p}_{g} ∖ g} \frac{L}{{c}_{s}^{{l}_{i - j}} - {x}_{i , j}^{s , t}} \leq {Δ}_{s} \qquad C6$$

$$∀ g ∈ G$$

$$∀ p ∈ {P}_{g}$$

Lastly, the flow conservation should be satisfied at all nodes, that is:

$${\sum }_{j} {x}_{i , j}^{s , t} = {\sum }_{i} {x}_{j , i}^{s , n} \qquad C7$$

$$∀ s ∈ S$$

$$t = 1 , 2 , … , {T}_{p}$$

The objective of a network slice provider is to create the network slices with a minimum cost or a minimum amount of resources. This can be achieved by solving an optimization problem written as:

$$min {\sum }_{m , s , f} {α}_{m , s}^{v} {w}_{m , s}^{v}$$

$$subject to constraints C 1 , C 2 , … , C 7$$

where α_{m,s}^{v} is the cost of one unit of resource type m at the service node v∈( [symbol] ∪ [symbol] ) , when it is allocated to network slice s.

Autonomous networking requires optimum resource and service acquisitions in quick time. However, optimization-based resource allocation/analysis may not be convenient because it is time consuming, especially, for large-scale problems with large number of traffic profiles. Therefore, embodiments also provide for a distributed AI-based resource allocation scheme.

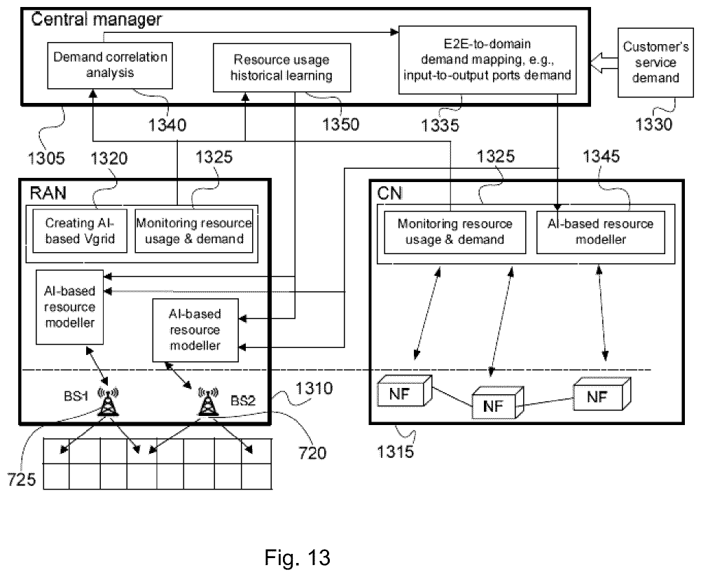

FIG. 13 illustrates a functional diagram for a distributed AI-based resource allocation scheme, according to embodiments. The management architecture is composed of two management layers: the first being a central manager 1305, and the second including two domain managers: a RAN manager 1310 and a CN manager 1315. A functionality of creating 1320 AI-based Vgrids can be managed by the RAN manager and the resultant Vgrid information can be sent to the central manager 1305. The domain managers 1310, 1315 also monitor 1325 the processed traffic, resource usage and demand of the service nodes, per service, per Vgrid and sends the data to the central manager. The main role of the central manager 1305 is to manage an E2E service slice and to ensure that the E2E customer's service requirements are satisfied.

Upon receiving the customer's service demand 1330 or requirement, the central manager 1305 maps 1335 the customer's specific requirements provided over the service area 355 into domain-specific requirements. This E2E-to-domain conversion 1335 can be done taking into account domain-related information, e.g., available resources, loading of service nodes, resource cost, etc. (this is for open domains). Alternatively, for closed domains, E2E-to-domain requirements can be done based on an abstracted view of the domain, e.g., domain's service capacity defined in terms of communication service types discussed previously. The domain-specific requirements can be defined in terms of ingress-to-egress requirements.

The central manager 1305 does 1340 demand (traffic) correlation analysis and resource usage historical learning 1350 for all domains contributing to the E2E service slice. Upon converting the customer's service requirements into domain-specific requirements, the central manager 1305 informs the domain managers with the domain-specific requirements. There can be negotiations or multiple rounds between the central manager 1305 and domain managers before they agree on the domain-specific requirements.

In this architecture, RAN domain resources (e.g., bandwidth) are allocated to the grids 360 of the service area 355 in a distributed manner, due to the expected scalability issues. There could be large number of grids 360 and base stations (BS) 725, 720. Each BS 725 has an AI-based resource modeller which allocates the resources to the grids 360 according to the RAN-specific requirements set by the central manager 1305. The RAN-specific requirements may include traffic demand per grid and percentage of users served by each BS 725, 720. For other domains, e.g., the CN domain, the resources could be allocated in a central manner by the CN manager 1315, because it is unlikely that the number of ingress ports of the CN is large.

For simulation purposes, a network, as shown in FIG. 12, includes 4 NFs 1205 and 3 base stations 1210, where each base station's coverage area is divided into 4 grids 360, making a total of 12 grids 1215. The three BSs are obtained from a standard 57-cell simulator (3 neighboring BSs can be selected). Four areas with different combinations of signal strength can be selected from each BS. The NFs can be deployed using four resource types. Forty (40) users can be assumed to be uniformly distributed over the 12 grids 1215.

Also, two services can be provided with a user's peak data rate of 0.2 Mbits/sec for service 1, and 0.1 Mbits/sec for service 2. There can be a delay of 50 milliseconds for service 1, and 40 milliseconds service 2. To have a fair comparison, the same traffic profiles are used in the simulation-based and optimization-based resource allocation.

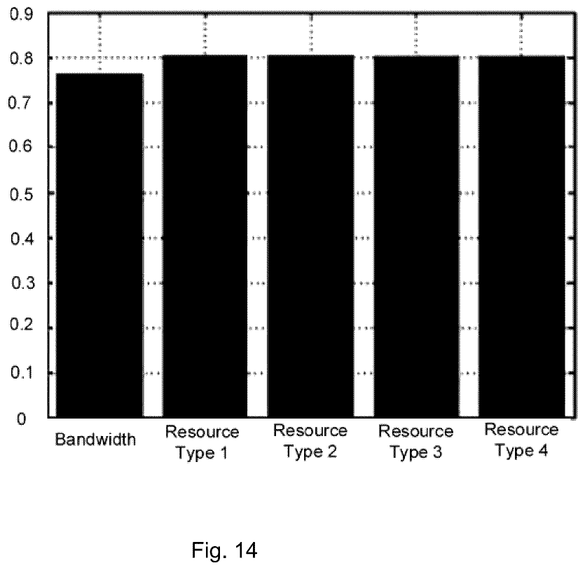

FIG. 14 is a graph showing the ratio of an optimization-based resource allocation to a simulation-based resource allocation, for five types of resources, with a system as shown in FIG. 12. An optimization-based scheme can result in about 20-25% less resources being used compared to a simulation-based scheme. Because a simulation-based scheme cannot optimize resources across grids (within a traffic profile) and across traffic profiles, it cannot find a solution without considering the various resource solutions together. In addition, a simulation-based scheme requires lengthy evaluations and is not suitable for on-demand or dynamic slice provisioning.

The results in FIG. 14 can suggest that a usual Monte Carlo based approach cannot be used for resource allocation. However, when there is a large number of grids, an optimization-based scheme according to embodiments can be very time consuming. Therefore, its suitability for autonomous service provisioning in a large-scale network can be questionable.

To find resource requirements across multiple domains for expected (predicted) traffic demand profiles of a slice in operation, the following scheme can be used. In this scheme, a certain amount of resources is added to a present use of resources, based on statistics of past traffic correlation and traffic variations.

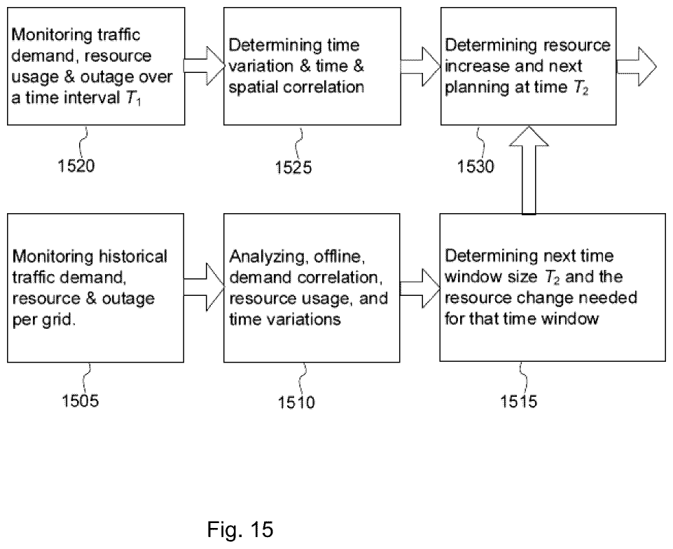

FIG. 15 illustrates a method to update the resource allocation across multiple domains to a slice in operation, according to an embodiment. Initially, the method involves monitoring 1505 historical traffic demand, resource usage and network outage, per grid, and per service and determining RRUT as explained previously.

Then, it includes analyzing 1510 the monitored data offline, to determine the range of each statistical parameter of grid traffic variation, the statistical parameters including time and spatial correlation of the traffic demand, mean demand per grid, as well as time variations of grid demand. The range of a statistical parameter is between the observed lower and upper limits of the parameter. Then, different combinations of these parameters spread across the parameter ranges can be selected to represent possible traffic demand statistics that could exist in the system.

Next, for each selected traffic demand statistic (the statistical parameter combination), a large number of grid demand traffic profiles can be generated using simulations offline, and an outage for different levels of percentage changes in resources assignment can be determined. Then, a look-up table can be prepared 1515 offline to relate the increase or decrease of resources required as a function of time and spatial correlation, mean of the grid traffic, grid traffic time variation, and outage.

Then, for each grid, traffic demand, resource usage and outage can be monitored 1520 over a time interval T₁. The monitored data can be analyzed to determine 1525 the time and spatial correlation, and time variations, of the traffic.

Then, the method can include determining 1530 how many additional resources are required, adding those resources to the current usage. This amount can be used during the next time interval T₂ of the slice, and it is based on the evaluation of past time and spatial correlations, and time variations, of the traffic.

Because larger variations in resource requirements are unlikely to occur, a simple way to allocate resources is to add a certain percentage of resources to the current amount of resources. Also, because the correlations and variations in demand can be measured using past traffic profiles, the percentage of resources to be added to avoid outage can be determined based on the past time and spatial correlations, and time variations, of the traffic.

Embodiments include a method to find out the outage as a function of time and spatial correlations, and time variations, of the traffic. Basically, the method creates a number of potential future traffic profiles and determines the percentage of traffic profiles in an outage for a given time correlation, spatial correlation, and time variation. A lookup table such as Table 3 can be generated and used to determine the amount of resource increase, as a function of a traffic's past time and spatial correlations, and time variations. It should be noted that different levels of statistical parameters (time and spatial correlation, variation, peak traffic demand) can be applied for different geographic regions. In addition, an increase can be done for one type of resource without applying an increase or decrease for another resource. Further, different amounts of resource changes can be applied to different regions, depending on traffic variations in the regions associated with specific resources. For any of the above combinations of situations, an outage can be determined and stored in a massive table. The analysis in Table 3 is for a simplified scenario where the same traffic statistics are applied for all the regions considered, and the same percentage change is applied to all the resources considered equally.

TABLE 3
A look-up table to determine the increase of resource required
as a function of time correlation, as can be prepared 1515
according to an embodiment.

| Increase | | |
|---|---|---|
| in required | Outage probability | |
| resources | Time correlation of 0.7 | Time correlation of 0.3 |
| 5% | 34% | 43% |
| 10% | 17% | 26% |
| 15% | 8% | 15% |
| 20% | 5% | 8% |
| 25% | 0% | 5% |

The performance of the method in FIG. 15 can be compared with the first optimization-based scheme described around FIG. 12. For this comparison, the network shown in FIG. 12 can be simulated.

In a simulation, the network of FIG. 12 includes four NFs 1205 and three base stations 1210, where each base station's coverage area is divided into 4 grids, providing a total of twelve grids 1215. The three BSs can be obtained from a standard 57-cell simulator (3 neighboring BSs are selected) and four areas with different combinations of signal strength can be selected from each BS. Forty-eight (48) users can be uniformly distributed over the region (12 grids) with a peak data rate of 1 Mbits/sec and a delay of 50 milliseconds. This results in an average traffic demand of 4 Mbits/sec per grid.

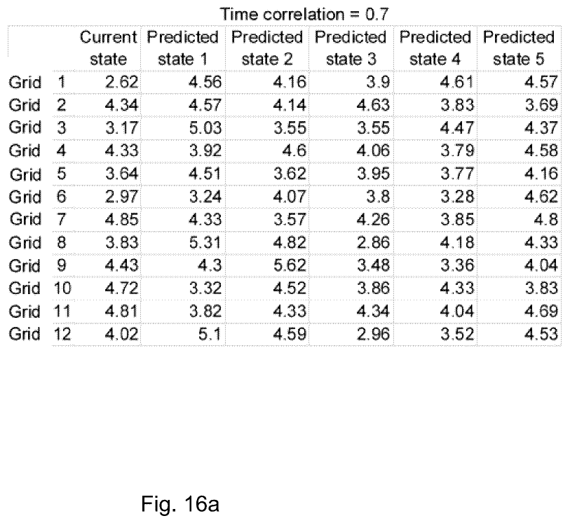

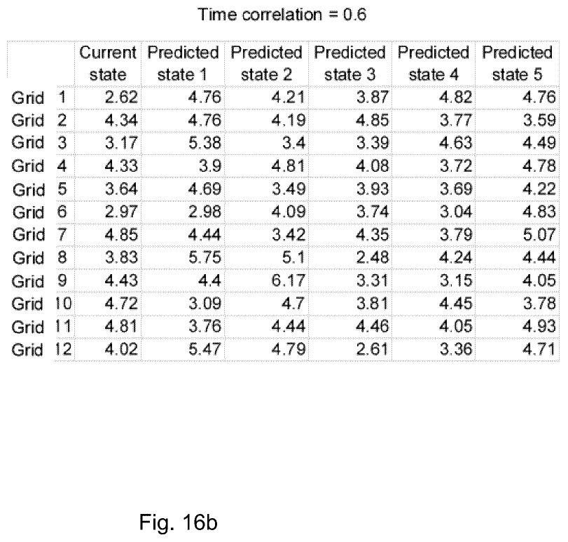

FIG. 16a shows an example of five predicted traffic profiles over 12 grids, created using a correlation model with a time correlation value of 0.7, and a decorrelation distance of 150 meters, according to an embodiment.

FIG. 16b shows an example of five predicted traffic profiles over 12 grids, created using a correlation model with a time correlation value of 0.6, and a decorrelation distance of 150 meters, according to an embodiment.

In a case where traffic is monitored over the past 50 time intervals, i.e., n₁=50 traffic profiles, as shown in FIG. 9, a traffic profile can initially be generated at time t=−50T using spatial correlation only. At t=−49T, a traffic profile is generated using both time and spatial correlation. This process is repeated until a traffic profile is generated for t=−T. Due to a lack of real data from an actual network, the demand samples for the network can be generated assuming a certain distance-based correlation value. The following are assumptions used for the generation of the demand vector with time and spatial correlations

The traffic's time correlation can be modelled using an autoregressive model, where the traffic demand of grid i at time t, denoted by Xₜⁱ, can be estimated from the past value at time t−1, i.e.:

$${X}_{t}^{i} = {ρ}_{i} {X}_{t - 1}^{i} + {ε}_{t}^{i} \sqrt{1 - {ρ}_{i}^{2}}$$

where: εₜⁱ˜N(0,1), which is a normal distribution with a mean of 0 and a standard deviation of 1, and
ρᵢ is the time correlation coefficient of traffic demand at grid i, between Xₜⁱ and Xₜ₋₁ⁱ:

$${ρ}_{i} = E [ {X}_{t}^{i} {X}_{t - 1}^{i} ]$$

The traffic's spatial correlation can be modelled similarly to a shadowing cross-correlation, which is a correlation that decreases as the distance between the areas increases. One common choice is:

$${ρ}_{ij} = exp ( - \frac{{d}_{ij}}{{d}_{corr}} )$$

where dᵢⱼ is the distance between grid i and grid j, and d_{corr} is the decorrelation distance, which for example can be 150 meters.

The generated time series Xₜⁱ, for i=1, 2, . . . , N, where N is the number of grids 360, should satisfy the time correlation:

$${ρ}_{i} = E [ {X}_{t}^{i} {X}_{t - 1}^{i} ] l$$

and a spatial correlation:

$${ρ}_{ij} = E [ {X}_{t}^{i} {X}_{t}^{j} ]$$

Knowing the past traffic demand profiles, the future traffic profile(s) for n₂ future time intervals can be predicted. Then, using the scheme described around FIG. 15, a given percentage increase of the resources can be evaluated to determine the outage probability.

Table 3 shows the outage probabilities for different percentage increases of the resources. As can be seen, if 25% more resources than the amount being currently used are added, a 0% outage can be obtained if the correlation is 0.7. Although this is a 0% outage probability, the actual outage will be higher because only 100 possible traffic profiles are considered, but it will be close to zero. When the time correlation is low, the outage increases. At a 25% resource increase, a 5% outage is observed when the correlation is 0.3. The objective of this scheme is to prepare, offline, a chart like Table 3 as a lookup table for different correlation values (both time and spatial) and for different outage values. Once these values are obtained from the past demand vectors, an operator can determine the resource requirement using this chart.

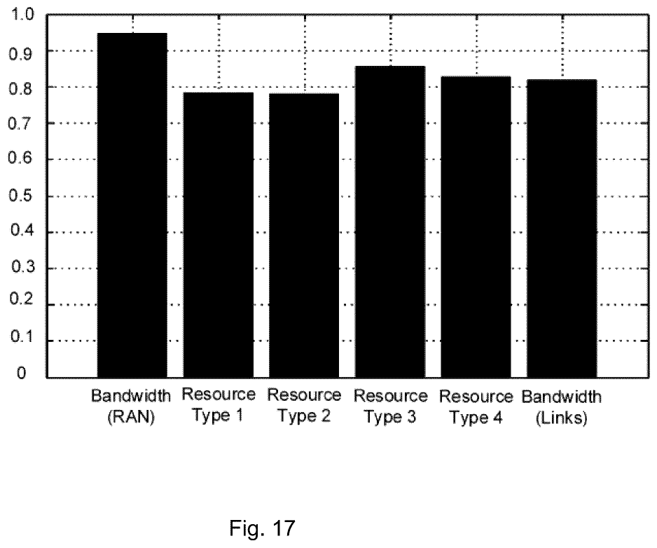

FIG. 17 shows the resource usage ratio of the optimization-based scheme (scheme 1) to the scheme based on percentage increase of resources (scheme 2), according to embodiments. The figure shows that scheme 1 allocates about 20% less resources than scheme 2. The reason is that scheme 2 does not optimize the resources across the traffic profiles, as in the case of scheme 1.

The use of domain abstractions to determine minimum resources for a customer slice can be done with one of two schemes to convert a user demand into grid-based traffic demand profiles: a simulations-based scheme and a mathematical-based scheme. This data is then utilized to obtain Vgrids, as well as to create historical data. Embodiments also proposes an optimization-based method to efficiently allocate resources to slices. To address the resource allocation problem, embodiments also provide a distributed AI-based architecture.

The solutions proposed herein, for resource minimization across multiple domains, can require interactions between several entities and administrative or management domains, e.g., service customer, service provider, central manager, and domain managers. Embodiments provide several procedures that can take place within a minimization solutions or method.

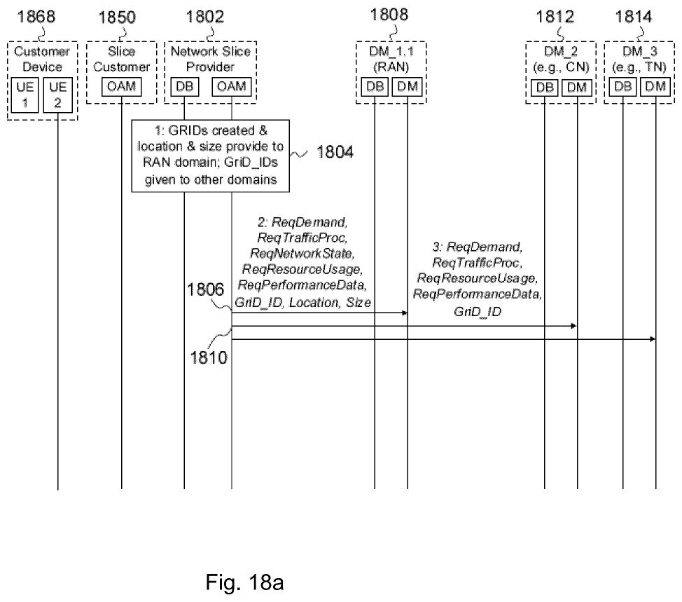

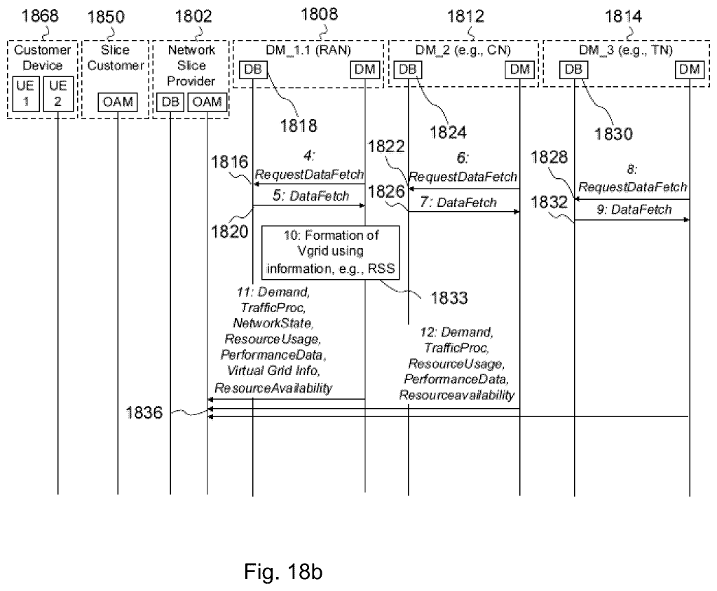

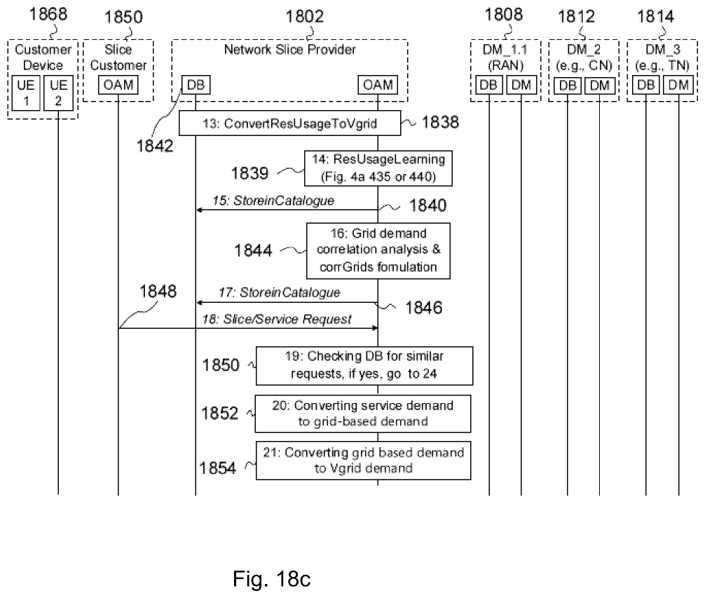

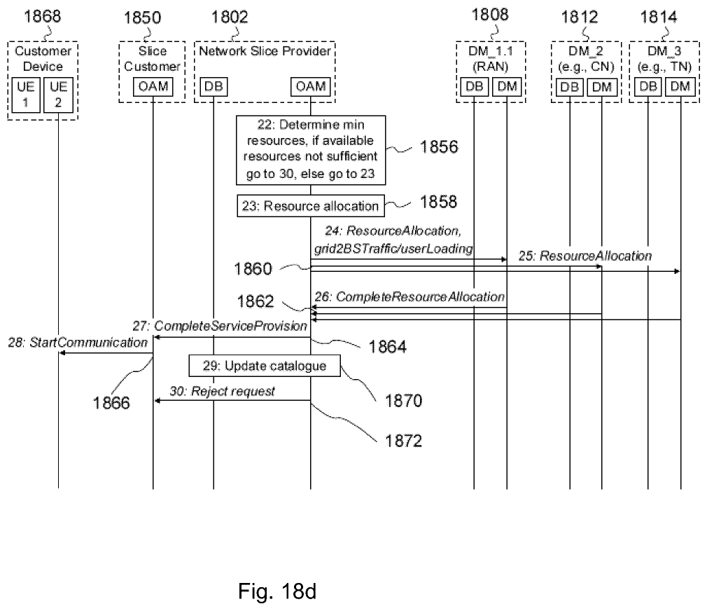

FIG. 18a to FIG. 18d represent a call flow diagram for a resource minimization procedure during provisioning phase, according to an embodiment. Details of the central procedure are as follows.

Initially, a central OAM 1802 of a network slice provider creates 1804 a gridded map and provides 1806 grid information to a RAN domain manager 1808. The map information can include grid ID, location, and size. Grid IDs can be provided 1810 to other domain managers as well, including a core network manager 1812 and a transport network manager 1814.

The central OAM 1802 can send a request to the domain managers 1808, 1812, 1814, to monitor service nodes (e.g., BSs, routers, NFs), and can log relevant data for each slice, for each service type, and for each source and destination nodes (e.g., BSs, geographic locations, and NFs). Examples of such data include resource usage, amount of processed traffic, available resources, delays, path losses. For example, in the RAN domain, this can include the amount of traffic, resource usage similarity, or path loss similarity per slice, per grid per service type, for a given duration.

Then, the central OAM 1802 sends a request to the domain managers 1808, 1812, 1814 to provide the relevant data. Each domain manager can obtain the data from a related database. The RAN domain manager 1808 can request 1816 data from its database 1818 and obtain 1820 the data. The CN domain manager 1812 can request 1822 data from its database 1824 and obtain 1826 the data, and the TN domain manager 1814 can request 1828 data from its database 1830 and obtain 1832 the data. In some cases, data can be sent periodically at agreed times. It can also be sent when a domain manager decides that new monitoring data has to be made available to the central OAM 1802.

The RAN domain can then use similarities between data from geographic grids (e.g. resource usage similarities and/or path loss similarities) to form 1833 Vgrids, and send the Vgrid information to the central OAM 1802. Then The OAM can convert 1838 the geographic grid-based resource usage to Vgrid-based resource usage.

After the data and/or Vgrids are received 1836 by the central OAM 1802, it can trigger 1839 a resource usage learning process for each service node, per slice, per service type, per source node, per network state. The purpose of a learning process is to learn mapping between traffic and resource requirements. Results can be stored 1840 in a related database 1842.

Then, the central OAM 1802 can analyze the received data to learn the spatial and time correlation of the traffic. This analysis helps the central OAM 1802 create 1844 correlated grids (“CorGrids”), which are needed to generate the expected traffic demand profiles. These can also be stored 1846 in a related database 1842. Having completed learning for resource usage and traffic correlation, the central OAM 1802 is ready to start service/slice provisioning if requested.

When the central OAM 1802 receives 1848 a service or slice request from the slice customer 1850, along with the service or slice requirements (SLA), the central OAM 1802 can check 1850 its data base 1842 to locate similar historical requests. Then, the central OAM 1802 converts 1852 the service demand into grid-based demand. Then, the grid-based demand is converted 1854 to a Vgrid demand expected traffic demand profiles that are also mapped to Vgrid-based expected traffic demand profiles.

Then, the central OAM 1802 determines 1856 the minimum resource requirement to support the Vgrid-based expected traffic demand profiles. For this, the central OAM 1802 can use one of the historical learning methods of FIG. 4: finding 435 historical resource requirements for each Vgrid, or obtaining 440 resource requirements for different Vgrid demand profiles. The central OAM 1802 can also determine the percentage of users (traffic) in a grid to be served by each base station. It can then allocate 1858 the resources.

Then, the central OAM 1802 can provide 1860 the resource allocation data to the domain managers 1808, 1812, 1814. Upon receiving 1862 a confirmation from the domain managers that the resources are allocated, the central OAM 1802 can make 1864 the service/slice available to the slice customer 1850, which can allow 1866 a customer device 1868 to start a communication. The central OAM 1802 can update 1870 its database with the new resource allocation. In some cases, the central OAM 1802 can reject 1872 a request.

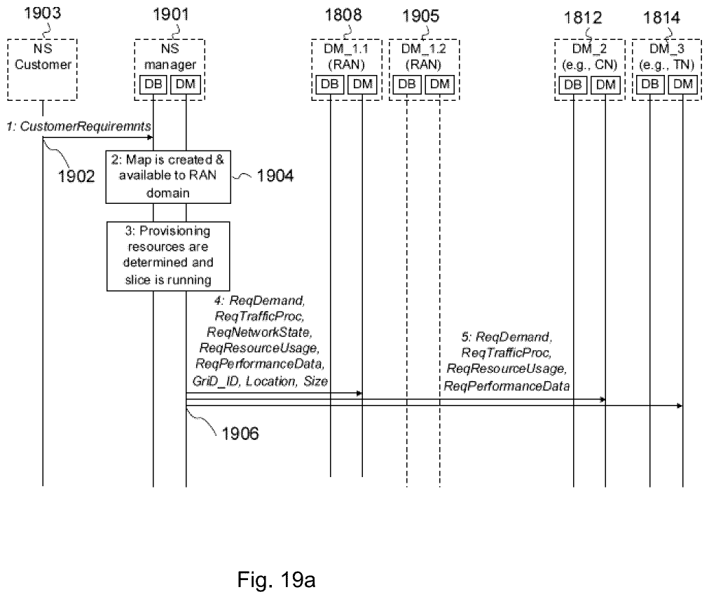

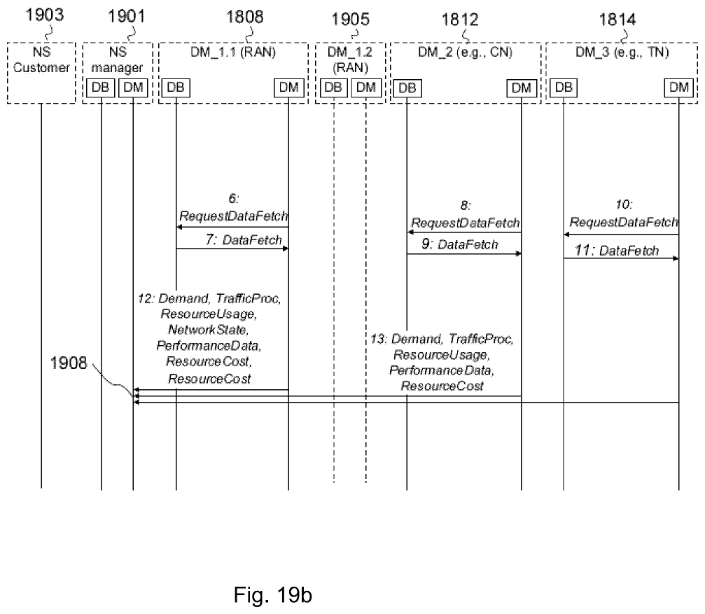

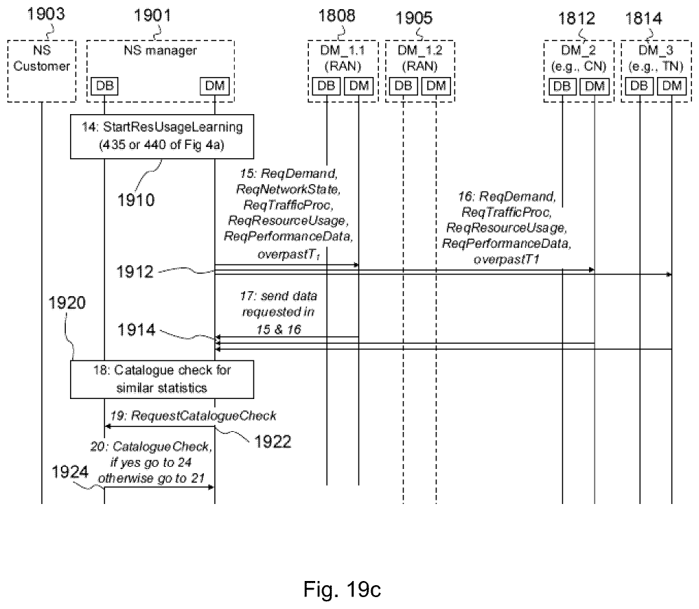

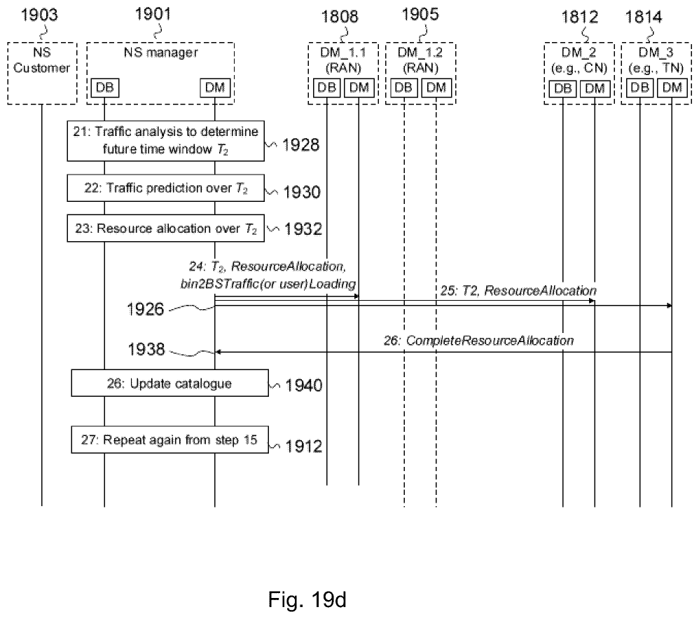

FIG. 19a to FIG. 19d represent a procedure to allocate resources to a slice during run-time, according to an embodiment.

A network slice manager 1901 obtains 1902 customer requirements from a network slice customer 1903 to obtain a network slice. The network slice manager then creates 1904 a gridded map, and makes the map information available to a RAN domain manager 1808. Resource provisioning can be determined, and a slice can be running. In an embodiment, there can be an additional RAN domain manager, such as DM_1.2 (RAN) 1905.

Then, the network slice manager 1901 sends 1906 requests to the domain managers 1808, 1812, 1814 to monitor service nodes (e.g., BSs, routers, NFs). The network slice manager 1901 logs relevant data for each slice, for each service type, for each source and for destination nodes (e.g., BSs, geographic locations, and NFs). Examples of such data are resource usage, amount of traffic, available resources, delay. In the RAN domain, the amount of traffic and resource usage per slice, per grid per service type for a given duration can be monitored.

The network slice manager 1901 sends a request to the domain managers to receive 1908 the relevant data needed for historical learning. Examples of such data include:
demand per slice per service type per source location for a period of time,
resource usage at service nodes per slice per service type per source location,
amount of traffic processed at service nodes per slice per service type per source location,
E2E performance for the said traffic per slice per service type per source location.

The network slice manager 1901 can trigger 1910 a resource usage learning process for each service node, per slice, per service type, per source node, and per network state. The aim of a learning process is to learn traffic-to-resource mapping.

The network slice manager 1901 can send 1912 a request to the domain managers to monitor relevant data such as traffic and resource usage over a past time interval T₁. This data can be used to update slice resources for a future time interval T₂. In some cases, this data is sent if a domain manager detects a performance degradation, or if resources are underutilized.

After obtaining 1914 the requested data, the network slice manager 1901 can perform a data analysis and based on this analysis, it can trigger a resource policy adaptation. A resource adaptation can begin if a performance failure or degradation is detected, or if allocated resources are underutilized.

The network slice manager 1901 can check 1920 its database, by requesting 1922 a catalog check, to see if past statistics or contexts are similar to the present one, and available (e.g., similar traffic statistics, correlations, resource usage, and corresponding resource requirements). If so 1924, the network slice manager 1901 configures 1926 the domain(s) with the new policy. The new policy can include the resource requirement per slice per service type per source location. It can also include the service node loading per slice per service type per source node (e.g., grid-BS traffic loading)

If a decision cannot be made based on past decisions, the network slice manager 1901 can perform 1928 traffic analysis and make traffic predictions 1930 for a future time interval T₂.

The network slice manager 1901 can set the new policy and allocate 1926 resources for T₂ based on the predicted traffic, resource usage analysis, available resources, and required QoS. It then configures the domains according to the new policy. For this, it sends the resulting data and traffic loading to the domain managers.

Once the network slice manager 1901 allocation is notified that allocation is complete 1938, it can log the new data and decisions, and update 1940 the catalogue accordingly for possible future use, and repeat monitoring requests 1912 as needed.

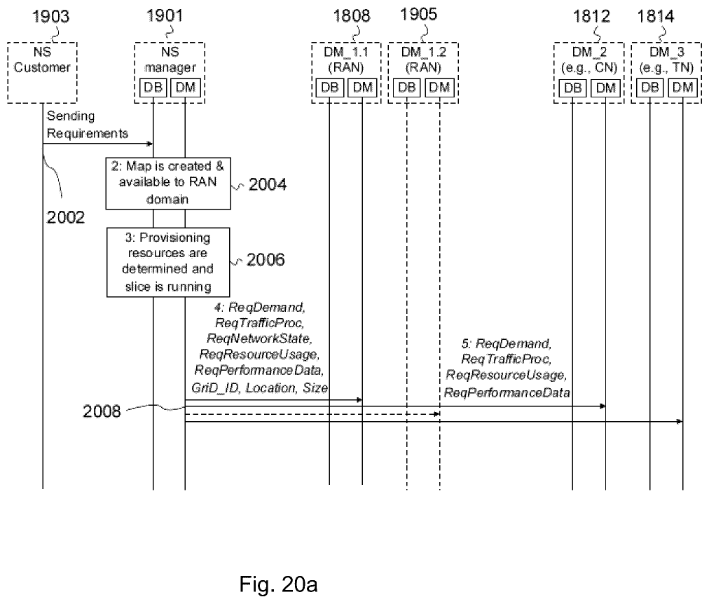

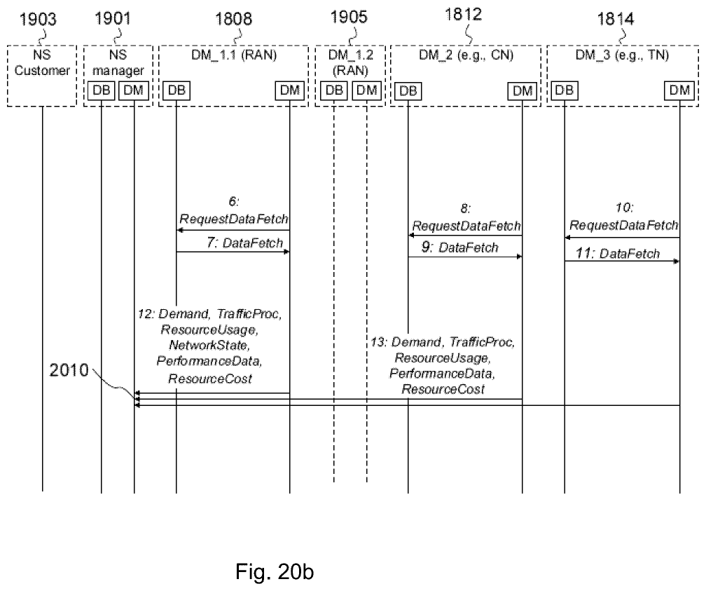

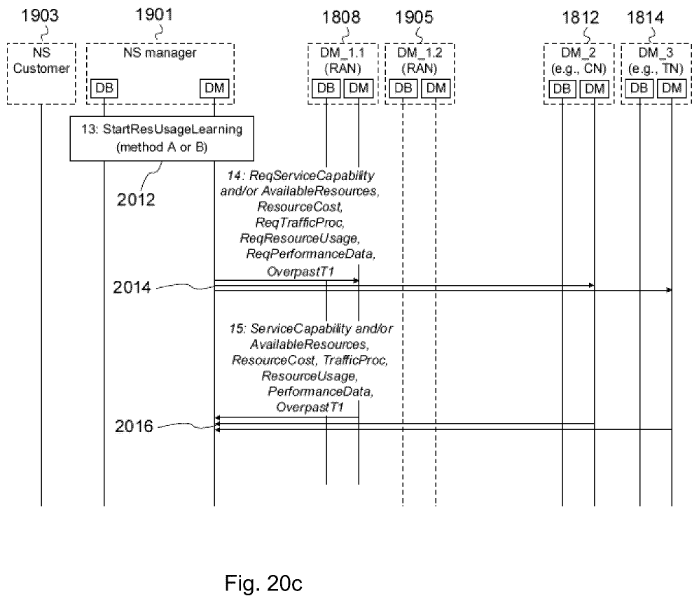

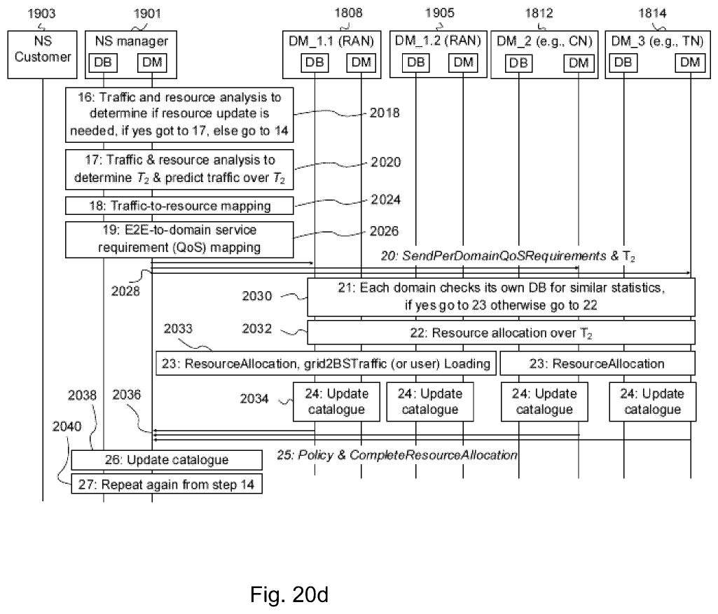

FIG. 20a to FIG. 20d represent a hybrid procedure for network slice resource adaptation during run-time, according to an embodiment. The details of a hybrid procedure can be as follows.

Initially, following reception 2002 of customer requirements, the slice manager 1901 creates 2004 a gridded map and the map information is made available to the domain managers. Resource provisioning can be determined, and slice can be running 2006

Then, the network slice manager 1901 sends 2008 a request to the domain managers to monitor the service nodes (e.g., BSs and NFs), and logs relevant data for each slice, for each service type, for each source location. Examples of such data are resource usage, the amount of traffic, available resources, and delay. For the RAN domain, traffic and resource usage per slice per service type per grid can also be monitored.

The network slice manager 1901 can send a request to obtain 2010 from the domain managers data needed for historical learning. Examples of such data are:
resource usage at service nodes per slice per service type per source node per network state for a period of time,
amount of traffic processed at service nodes per slice per service type per source location per network state, and
E2E performance for the said traffic per slice per service type per source location per network state

The network slice manager 1901 can trigger 2012 a resource usage learning process for each service node per slice per service type per source node per network state. The aim of the learning process is to learn traffic-to-resource mapping.

The network slice manager 1901 sends 2014 a request to the domain managers to monitor relevant data, e.g., traffic and resource usage over a past time interval T₁. This data is needed and obtained 2016 for updating slice or service resources for a future time interval T₂. In some cases, this relevant data is sent if a domain manager detects a performance degradation, or if resources are underutilized.

The network slice manager 1901 performs 2018 data analysis and based on this analysis, it can trigger a resource policy adaptation.

The network slice manager 1901 can perform another 2020 data analysis and based on this analysis, it can determine T₂ and predict traffic over the future interval T₂. This can also depend on whether a performance failure/degradation is detected, or whether allocated resources are underutilized. Then, there can be a traffic-to-resource mapping 2024.

The network slice manager 1901 can map 2026 E2E to domain service requirements. Multiple rounds of negotiations might be needed before the slice manager 1901 and the domain managers reach an agreement on service requirement mapping. The network slice manager 1901 then sends 2028 the domain service requirements to the domain managers.

Each domain manager can check 2030 its own catalog to see if similar statistics or contexts are available from the past (e.g., similar traffic statistics, correlation, and resource usage and domain QoS requirements). If yes, the domain managers can configure their domains and allocate 2033 resources over T₂ according to the policy available in the catalogs. The new policy can include the resource requirement per slice per service type per source node. It can also include the service node loading per slice per service type per source node (e.g., grid-to-BS traffic loading).

If no similar statistics or contexts are available in the domain catalogs, the domain managers can derive the new policy for the future period of time, based on the domain service requirements received from the network slice manager 1901 and the domain managers, then configure and allocate 2032 resources over T₂ with the new policy.

The domain managers can log the new data and new policies, and update 2034 their own catalogues accordingly for possible future use. Then, the network slice manager 1901 can obtain the derived policies 2036 from the domain managers. The network slice manager 1901 can then update 2038 its own catalogue with the complete resource allocation, using the derived policies 2036. The network slice manager 1901 can sends 2040 further requests to the domain managers to monitor for further time intervals as needed.

Embodiments include a grid-based framework for optimizing the resources allocated to a slice when customer requirements are given over a large area. A method according to embodiments can include domain abstraction by historical learning of resource usage, the formation of virtual and correlated grids, and mapping of service requirements to grid-based traffic profiles.

Embodiments include methods for grid-based single-domain abstraction and/or multi-domain abstraction, by monitoring the resource usage of a communication service type per grid and/or per virtual grid.

Embodiments include methods to learn the resource usage of a communication service type by learning the resource requirement per unit of traffic, per communication service type, and per grid and/or per virtual grid.

Embodiments include methods to learn the resource usage of a communication service type by storing the historical resource requirement of traffic profiles and by using quantization and interpolation methods.

Embodiments include methods to obtain virtual grid that enable abstraction of RAN domains and other domains for uplinks and downlinks, as well as other communication service types to reduce complexity.

Embodiments include methods to obtain correlated grids from geographic grids using historical demand correlations.

Methods according to embodiment can be used for wireline networks, non-terrestrial networks such as drones, high-altitude platforms (HAP) and low-earth orbit networks, by considering them as separate domains.

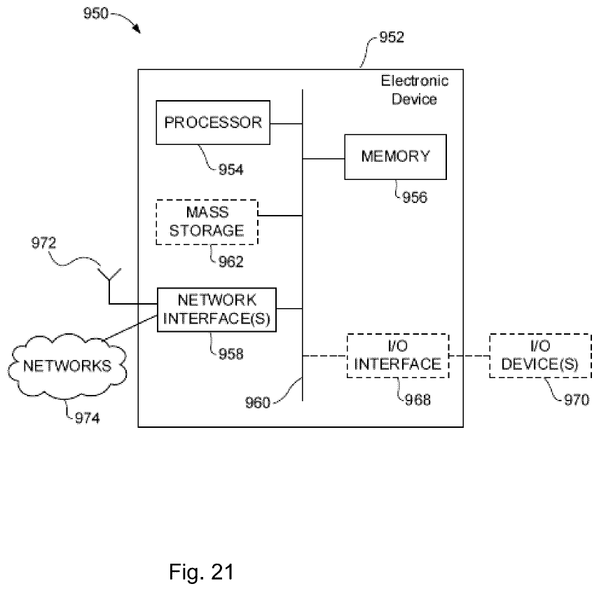

FIG. 21 is a block diagram of an electronic device (ED) 952 illustrated within a computing and communications environment 950 that may be used for implementing the devices and methods disclosed herein, such as a system for provisioning a service slice. The electronic device 952 typically includes a processor 954, such as a central processing unit (CPU), and may further include specialized processors such as a field programmable gate array (FPGA) or other such processor, a memory 956, a network interface 958 and a bus 960 to connect the components of ED 952. ED 952 may optionally also include components such as a mass storage device 962, a video adapter 964, and an I/O interface 968 (shown in dashed lines).

The memory 956 may comprise any type of non-transitory system memory, readable by the processor 954, such as static random-access memory (SRAM), dynamic random-access memory (DRAM), synchronous DRAM (SDRAM), read-only memory (ROM), or a combination thereof. In an embodiment, the memory 956 may include more than one type of memory, such as ROM for use at boot-up, and DRAM for program and data storage for use while executing programs. The bus 960 may be one or more of any type of several bus architectures including a memory bus or memory controller, a peripheral bus, or a video bus.

The electronic device 952 may also include one or more network interfaces 958, which may include at least one of a wired network interface and a wireless network interface. A network interface 958 may include a wired network interface to connect to a network 974, and also may include a radio access network interface 972 for connecting to other devices over a radio link. The network interfaces 958 allow the electronic device 952 to communicate with remote entities such as those connected to network 974.

The mass storage 962 may comprise any type of non-transitory storage device configured to store data, programs, and other information and to make the data, programs, and other information accessible via the bus 960. The mass storage 962 may comprise, for example, one or more of a solid-state drive, hard disk drive, a magnetic disk drive, or an optical disk drive. In some embodiments, mass storage 962 may be remote to the electronic device 952 and accessible through use of a network interface such as interface 958. In the illustrated embodiment, mass storage 962 is distinct from memory 956 where it is included and may generally perform storage tasks compatible with higher latency but may generally provide lesser or no volatility. In some embodiments, mass storage 962 may be integrated with a heterogeneous memory 956.

In an embodiment, a system for provisioning a service slice can comprise at least one processor 954; a machine readable memory 956 storing machine readable instructions which when executed by the at least one processor 954, configures the at least one processor 954 to implement a slice resource allocator (which may be part of a network slice manager), the network slice manager operative to receive a statistical representation of a customer traffic demand requirement over a specified geographic area, the customer traffic demand being an aggregated traffic demand of an end user population, associated with a customer, and to be met by the service slice; determine a set of virtual grid demand profiles for a set of virtual grids operative to support the statistical representation of the customer traffic demand requirements, with each virtual grid being a set of geographic grids with similar radio network parameters, the set of geographic grids being of similar size and covering the specified geographic area; determine an amount of resources that is sufficient to satisfy each virtual grid demand profile of the set of virtual grid demand profiles; and send an indication of the amount of resources to at least one network manager to implement the service slice. The network interface 974 and I/O interface 968 can also allow for storage and/or processing to occur externally.

In an embodiment, a system for provisioning a service slice during run-time can comprise at least one processor 954, and machine readable memory 956 storing machine readable instructions which when executed by the at least one processor 954, configures the at least one processor 954 to implement a slice resource allocator (which may be part of a network slice manager), the slice resource allocator operative to receive a statistical representation of a customer traffic demand profiles monitored over a geographic area for one or more past time intervals; determine a set of virtual grid demand profiles for a set of virtual grids operative to support a customer traffic demand at a future time interval, with each virtual grid being a set of geographic grids with similar radio network parameters, the set of virtual grids covering the specified geographic area; analyze the set of virtual grid demand profiles for associated resource usage and performance for one or more past time intervals; determine an amount of resources that is sufficient to satisfy each virtual grid traffic demand profile during the future time interval; and send a request to at least one network manager to implement the service.

In some embodiments, electronic device 952 may be a standalone device, while in other embodiments electronic device 952 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method of provisioning a service slice comprising:
receiving, by a slice resource allocator, a statistical representation of a customer traffic demand over a specified geographic area, the customer traffic demand being an aggregated traffic demand of an end user population, associated with a customer, and to be met by the service slice, the specified geographic area is divided into a set of geographic grids of equal size;
determining, by the slice resource allocator, a set of geographic grid demand profiles for the set of geographic grids operative to support the statistical representation of a customer traffic demand, with each geographic grid served by at least one base station;
determining, by the slice resource allocator, an amount of resources that is sufficient to satisfy each grid demand profile of the set of geographic grid demand profiles; and
sending, by the slice resource allocator, an indication of the amount of resources to at least one network manager to implement the service slice.

2. The method of claim 1 wherein:
the service slice spans a plurality of domains;
determining, by the slice resource allocator, a set of geographic grid demand profiles comprises determining, by the slice resource allocator, a set of virtual grid demand profiles for a set of virtual grids operative to support the statistical representation of a customer traffic demand, with each virtual grid being a set of geographic grids with similar radio network parameters, the set of geographic grids being of similar size and covering the specified geographic area;
determining, by the slice resource allocator, an amount of resources comprises determining, by the slice resource allocator, a common set of resources to satisfy each virtual grid demand profile in the set of virtual grid demand profiles, the amount of resources including resources from one or more of the plurality of domains and indicating the amount of resources for each resource type required; and
the method further comprises the network manager sending a request, to one or more domain managers of the plurality of domains, to implement the service slice using the amount of resources, according to the indication.

3. The method of claim 2 wherein determining, by the slice resource allocator, a common set of resources comprises:
performing, by the slice resource allocator, a historical analysis of resource usage information of past time intervals for various services using monitored data on resource usage in each domain for each virtual grid;
providing, by the slice resource allocator, the results of the historical analysis to a resource modeller; and
determining by the resource modeller the common set of resources to satisfy the set of virtual grid demand profiles.

4. The method of claim 3, wherein the historical analysis comprises:
analyzing the monitored data to determine the resources required for each domain to provide a data unit of traffic (RRUT) for each virtual grid, for each service type or quality of service (QoS), for each potential traffic path at different network states.

5. The method of claim 3, wherein the historical analysis comprises:
analyzing the resources required for each domain for each potential virtual grid demand profile in the geographic area;
quantizing the virtual grid demand profiles to reduce the number of potential virtual grid demand profiles by quantizing each virtual grid demand into a few quantized demand levels;
analyzing a resource requirement similarity among the quantized virtual grid demand profiles;
classifying the quantized virtual grid demand profiles into a smaller distinguished set of virtual grid demand profiles using the resource requirement similarity analysis; and
determining an amount of resources required to satisfy each virtual grid demand profile of the smaller distinguished set of virtual grid demand profiles.

6. The method of claim 3 wherein determining by the resource modeler, the common set of resources to satisfy the set of virtual grid demand profiles comprises: determining, by a resource modeller, a common resource assignment from each domain to satisfy the set of virtual grid demand profiles by an optimization algorithm using the results of a historical analysis of resource usage for different traffic demands.

7. The method of claim 2, wherein determining, by the slice resource allocator, a set of virtual grid demand profiles for a set of virtual grids operative to support the statistical representation of a customer traffic demand comprises:
determining, by the slice resource allocator, a set of potential traffic demand profiles across the virtual grids to represent the statistical representation of the customer traffic demand such that satisfying the potential demand profiles satisfies the statistical representation of the customer traffic demand.

8. The method of claim 7, wherein determining, by the slice resource allocator, a set of potential traffic demand profiles across the virtual grids to represent the statistical representation of the customer traffic demand such that satisfying the potential demand profiles satisfies the statistical representation of the customer traffic demand comprises:
determining a potential set of traffic demand profiles across the correlated grids based on the correlation among the correlated grids and distributing the correlated grid traffic demands of a traffic profile to its grids; and combining the resulting grid traffic of a virtual grid to determine the virtual grid demand profiles.

9. The method of claim 1, wherein the statistical representation of the customer traffic demand over a specified geographic area includes quality of experience requirements and outage requirements over the geographic area.

10. The method of claim 1, wherein receiving a statistical representation of a customer traffic demand includes determining previous grid demand profiles based on monitoring changes of the traffic demand over regular intervals.

11. A system for provisioning a service slice comprising:
at least one processor, and
machine readable memory storing machine readable instructions which when executed by the at least one processor, implements slice resource allocator;
the slice resource allocator is configured to:
receive a statistical representation of a customer traffic demand over a specified geographic area, the customer traffic demand being an aggregated traffic demand of an end user population, associated with a customer, and to be met by the service slice, the specified geographic area is divided into a set of geographic grids of equal size;
determine a set of geographic grid demand profiles for the set of geographic grids operative to support the statistical representation of a customer traffic demand, with each geographic grid served by at least one base station;
determine an amount of resources that is sufficient to satisfy each grid demand profile of the set of geographic grid demand profiles; and
send an indication of the amount of resources to at least one network manager to implement the service slice.

12. The system of claim 11 wherein:
the service slice spans a plurality of domains;
determine a set of geographic grid demand profiles comprises determine a set of virtual grid demand profiles for a set of virtual grids operative to support the statistical representation of a customer traffic demand, with each virtual grid being a set of geographic grids with similar radio network parameters, the set of geographic grids being of similar size and covering the specified geographic area;
determine an amount of resources comprises determine a common set of resources to satisfy each virtual grid demand profile in the set of virtual grid demand profiles, the amount of resources including resources from one or more of the plurality of domains and indicating the amount of resources for each resource type required; and
the network manager is configured to send a request, to one or more domain managers of the plurality of domains, to implement the service slice using the amount of resources, according to the indication.

13. The system of claim 12, wherein determine a common set of resources comprises:
performing a historical analysis of resource usage information of past time intervals for various services using monitored data on resource usage in each domain for each virtual grid;
providing the results of the historical analysis to a resource modeller, the resource modeller is configured to determine the common set of resources to satisfy the set of virtual grid demand profiles.

14. The system of claim 13, wherein the historical analysis comprises:
analyzing the monitored data to determine the resources required for each domain to provide a data unit of traffic (RRUT) for each virtual grid, for each service type or quality of service (QoS), for each potential traffic path at different network states.

15. The system of claim 13, wherein the historical analysis comprises:
analyzing the resources required for each domain for each potential virtual grid demand profile in the geographic area;
quantizing the virtual grid demand profiles to reduce the number of potential virtual grid demand profiles by quantizing each virtual grid demand into a few quantized demand levels;
analyzing a resource requirement similarity among the quantized virtual grid demand profiles;
classifying the quantized virtual grid demand profiles into a smaller distinguished set of virtual grid demand profiles using the resource requirement similarity analysis; and
determining an amount of resources required to satisfy each virtual grid demand profile of the smaller distinguished set of virtual grid demand profiles.

16. The system of claim 13, wherein the resource modeller is configured to determine the common set of resources to satisfy the set of virtual grid demand profiles comprises: the resource modeller is configured to determine a common resource assignment from each domain to satisfy the set of virtual grid demand profiles by an optimization algorithm using the results of a historical analysis of resource usage for different traffic demands.

17. The system of claim 12, wherein determine a set of virtual grid demand profiles for a set of virtual grids operative to support the statistical representation of a customer traffic demand comprises:
determine a set of potential traffic demand profiles across the virtual grids to represent the statistical representation of the customer traffic demand such that satisfying the potential demand profiles satisfies the statistical representation of the customer traffic demand.

18. The system of claim 17, wherein determine a set of potential traffic demand profiles across the virtual grids to represent the statistical representation of the customer traffic demand such that satisfying the potential demand profiles satisfies the statistical representation of the customer traffic demand comprises:
determine a potential set of traffic demand profiles across the correlated grids based on the correlation among the correlated grids and distribute the correlated grid traffic demands of a traffic profile to its grids; and combine the resulting grid traffic of a virtual grid to determine the virtual grid demand profiles.

19. The system of claim 11, wherein the statistical representation of the customer traffic demand over a specified geographic area includes quality of experience requirements and outage requirements over the geographic area.

20. The system of claim 11, wherein receive a statistical representation of a customer traffic demand includes determine previous grid demand profiles based on monitoring changes of the traffic demand over regular intervals.
